(19) United States
(12) Patent Application Publication
(10) Pub. No.: US 2026/0262069 A1
(43) Pub. Date: Sep. 3, 2026

(54) DATA TRANSMISSION METHOD, DATA TRANSMISSION DEVICE, COMPUTER DEVICE AND STORAGE MEDIUM

(71) Applicants: Beijing BOE Technology Development Co., Ltd., Beijing (CN); BOE TECHNOLOGY GROUP CO., LTD., Beijing (CN)

(72) Inventor: Rongzuo ZHANG, Beijing (CN)

(21) Appl. No.: 18/994,668

(22) PCT Filed: Apr. 21, 2023
(86) PCT No.: PCT/CN2023/089732

§ 371 Date: Jan. 15, 2025

(51) Int. Cl. H04W 72/52

(52) U.S. Cl. CPC H04W 72/52

(57) ABSTRACT

Data transmission method and device, computer device and storage medium are provided and belong to field of data processing technology. Method includes determining, by server, first data scheduling plan of first terminal in response to data scheduling request sent by first terminal according to first data volume of to-be-transferred data of first terminal in data scheduling request and terminal information in server, and sending first data scheduling plan to first terminal, terminal information including information of terminal within gateway coverage; first data scheduling plan includes information of second terminal and second data volume receivable by second terminal, and second terminal is different from first terminal within gateway coverage; and receiving, by first terminal, first data scheduling plan, dividing to-be-transferred data with first data volume into pieces according to second data volume, to obtain each piece of sub-data, and sending each piece to second terminal.

### TECHNICAL FIELD

The present disclosure relates to the field of data processing technology, in particular to a data transmission method, a data transmission device, a computer device and a storage medium.

### BACKGROUND

With the popularization of smart devices, more and more user information, such as some relatively sensitive face recognition data stored locally in a camera device, some confidential information related to user privacy, or the like, is stored in the smart devices. Once the smart devices are attacked maliciously by a third party or damaged by a person, the privacy of the user may be revealed, and even the property security of the user may be threatened.

### SUMMARY

The present disclosure is directed to at least one of the technical problems in the related art, and provides a data transmission method, a data transmission device, a computer device and a storage medium.

In a first aspect, the technical solution of the present disclosure adopted for solving the technical problems is a data transmission method, including: by a server, determining, in response to a data scheduling request sent by a first terminal, a first data scheduling plan of the first terminal according to a first data volume of a to-be-transferred data of the first terminal carried in the data scheduling request and terminal information stored in the server, and sending the first data scheduling plan to the first terminal, wherein the terminal information comprises information of each of terminals within a signal coverage of a gateway, the first data scheduling plan comprises information of each of second terminals and a second data volume receivable by each second terminal, the first terminal is a terminal to transfer the to-be-transferred data therein within the signal coverage of the gateway, and the second terminal is a terminal among the terminals different from the first terminal within the signal coverage of the gateway; and, by the first terminal, receiving the first data scheduling plan, dividing the to-be-transferred data with the first data volume into a plurality of pieces of sub-data according to the second data volume receivable by each second terminal to obtain each piece of sub-data, and sending each piece of sub-data to the second terminal.

In some embodiments, the determining, by the server in response to a data scheduling request sent by a first terminal, the first data scheduling plan of the first terminal according to the first data volume of a to-be-transferred data of the first terminal carried in the data scheduling request and terminal information stored in the server, includes: initiating, by the first terminal, the data scheduling request to the server in response that it is detected by the first terminal that an internal storage margin of the first terminal is less than or equal to a first preset threshold; and determining, by the server in response to an internal storage exhaustion instruction indicated by the data scheduling request, the first data scheduling plan according to an internal storage margin of each terminal in the terminal information and the first data volume of the to-be-transferred data carried in the data scheduling request.

In some embodiments, the determining the first data scheduling plan according to the internal storage margin of each terminal in the terminal information and the first data volume of the to-be-transferred data carried in the data scheduling request, includes: selecting a terminal with the internal storage margin greater than or equal to a second preset threshold from the terminals according to the internal storage margin of each terminal in the terminal information, as the second terminal to receive the to-be-transferred data; and determining the second data volume of the to-be-transferred data receivable by each second terminal, according to a ratio of the internal storage margins of the second terminals and the first data volume of the to-be-transferred data.

In some embodiments, the first terminal and the second terminal are communicated with each other via a transmission control protocol TCP or an internet protocol IP.

In some embodiments, the determining, by a server in response to the data scheduling request sent by the first terminal, the first data scheduling plan of the first terminal according to the first data volume of the to-be-transferred data of the first terminal carried in the data scheduling request and terminal information stored in the server, comprises: initiating, by the first terminal, the data scheduling request to the server in response that it is detected by the first terminal that the first terminal is physically attacked; and determining, by the server in response to a physical attack instruction indicated by the data scheduling request, the first data scheduling plan according to the internal storage margin of each terminal in the terminal information and the first data volume of the to-be-transferred data carried in the data scheduling request.

In some embodiments, the determining the first data scheduling plan according to the internal storage margin of each terminal in the terminal information and the first data volume of the to-be-transferred data carried in the data scheduling request, comprises: selecting a terminal with the internal storage margin greater than or equal to a second preset threshold from the terminals according to the internal storage margin of each terminal in the terminal information, as the second terminal to receive the to-be-transferred data; determining a data transmission time length of each second terminal according to a data transmission speed of each second terminal and the first data volume of the to-be-transferred data, wherein the data transmission time lengths of the second terminals are the same; determining whether a data volume to be received by the second terminal exceeds the internal storage margin of the second terminal according to the data transmission speed and the data transmission time length of each second terminal; and determining the data volume to be received by the second terminal as the second data volume of the to-be-transferred data to be received in response that the data volume to be received by any second terminal does not exceed the internal storage margin of the second terminal.

In some embodiments, the data transmission method further includes: determining, in a case where the data volume to be received by the second terminal exceeds the internal storage margin of the second terminal, the second terminal as a target second terminal, and determining the second data volume receivable by the target second terminal as the internal storage margin of the target second terminal; and for remaining second terminals other than the target second terminal, returning to execute the determining the data transmission time length of each second terminal according to the data transmission speed of each second terminal and the first data volume of the to-be-transferred data, until the data volume to be received by each of the remaining second terminals does not exceed the internal storage margin of each of the remaining second terminals, and determining the second data volumes of the to-be-transferred data receivable by the remaining second terminals.

In some embodiments, the first terminal and the second terminal are communicated to each other via a user datagram protocol UDP.

In some embodiments, the sending the respective pieces of sub-data to the second terminals, includes: for each piece of sub-data, adding a group of first preset identifiers before the sub-data, and adding a group of first preset identifiers after the sub-data to obtain a data packet containing the preset identifiers and the sub-data, wherein the first preset identifiers added to different sub-data indicate different splicing sequence numbers; and respectively sending the data packets corresponding to the pieces of sub-data to the corresponding second terminals for reception.

In some embodiments, the data transmission method further includes: sending, by the first terminal, a first data recovery request to each terminal within the signal coverage of the gateway, so that each terminal determines whether the terminal is a terminal having stored the data packet of the first terminal in response to the first data recovery request; determining, by the second terminal in response to the first data recovery request, a data packet matched with the second preset identifier carried by the first data recovery request according to the first preset identifier in the data packet, and sending the data packet to the first terminal; and receiving, by the first terminal, the data packets sent by the second terminals, and splicing the sub-data in the data packets according to the splicing sequence numbers indicated by the first preset identifiers in the data packets to obtain recovery data.

In some embodiments, the data transmission method further includes: sending, by the first terminal, a first data recovery request to each terminal and the server within the signal coverage of the gateway, so that each terminal determines whether the terminal is the terminal having stored the data packet of the first terminal in response to the first data recovery request; determining, by the second terminal, whether the second preset identifier carried by the first data recovery request exists in the data stored in the second terminal in response to the first data recovery request; initiating a second data recovery request for requesting to recover the data transferred by the second terminal, in response to a command sent by the server for recovering the data of the second terminal, in a case where the data stored in the second terminal does not have the second preset identifier carried by the first data recovery request; and repeatedly executing the determining whether the second preset identifier carried by the first data recovery request exists in the data stored in the second terminal in response to the first data recovery request when data recovery of the second terminal is completed.

In some embodiments, the data transmission method further includes: determining whether the second preset identifier is packaged by additional identifiers in response that the second preset identifier carried by the first data recovery request exists in the data stored in the second terminal; and sending a data packet corresponding to the second preset identifier to the first terminal in response that the second preset identifier is not packaged by the additional identifiers.

In some embodiments, the data transmission method further includes: monitoring, by the second terminal, whether the terminal corresponding to the additional identifiers sends a third data recovery request, in response that the second preset identifier is packaged by the additional identifiers, so as to send the data packets corresponding to the additional identifiers to the terminals corresponding to the additional identifiers in response to the third data recovery request.

In some embodiments, the data transmission method further includes: receiving, by the server, terminal tasks and attribute information reported by the terminals to generate the terminal information of the terminals.

In some embodiments, the data transmission method further includes: periodically determining, by the server, according to the internal storage margin of each terminal, a third terminal that requires to transfer data; determining a second data scheduling plan of the third terminal according to a third data volume of a to-be-transferred data of the third terminal and the terminal information stored in the server, and sending the second data scheduling plan to the third terminal, wherein the second data scheduling plan includes information of each fourth terminal and a fourth data volume receivable by each fourth terminal, and the fourth terminal is a terminal different from the third terminal within the signal coverage of the gateway; and receiving, by the third terminal, the second data scheduling plan; and dividing the to-be-transferred data with the third data volume into a plurality of pieces according to the fourth data volume receivable by each fourth terminal, and respectively sending the plurality of pieces to the fourth terminals.

In some embodiments, the data transmission method further includes: detecting, by the server, an internal storage margin of each terminal, and initiating an internal storage cleaning request to each terminal within the signal coverage of the gateway in response that a total redundant space of the internal storage margin is less than or equal to a third preset threshold; and uploading, by the terminal, a to-be-cleaned data in the internal storage of the terminal to the server in response to the internal storage cleaning request.

In a second aspect, an embodiment of the present disclosure further provides a data transmission method, including: determining a first data scheduling plan according to a first data volume of a to-be-transferred data of a first terminal and terminal information received from a server in response to a data scheduling request, wherein the terminal information includes information of each of terminals in a signal coverage of a gateway, the first data scheduling plan includes information of each of second terminals and a second data volume receivable by each second terminal, the second terminal is a terminal among the terminals different from the first terminal in the coverage of the gateway; the first terminal is a terminal among the terminals which sends the data scheduling request within the signal coverage of the gateway; dividing the to-be-transferred data with the first data volume into a plurality of pieces according to the second data volume receivable by each second terminal to obtain each piece of sub-data; and sending each piece of the sub-data to the corresponding second terminal respectively.

In some embodiments, the determining the first data scheduling plan according to the first data volume of the to-be-transferred data of the first terminal and the terminal information received from the server, comprises: acquiring the terminal information from the server, and determining the first data scheduling plan according to an internal storage margin of each terminal in the terminal information and the first data volume of the to-be-transferred data in response to the data scheduling request initiated by the first terminal and indicating an internal storage exhaustion instruction, in a case where it is detected that the internal storage margin of the first terminal is less than or equal to a first preset threshold.

In some embodiments, the determining the first data scheduling plan according to the internal storage margin of each terminal in the terminal information and the first data volume of the to-be-transferred data, includes: selecting terminals with the internal storage margin greater than or equal to a second preset threshold from the terminals as second terminals to receive to-be-transferred data from the terminals according to the internal storage margin of each terminal in the terminal information; and determining the second data volume of the to-be-transferred data receivable by each second terminal, according to a ratio of the internal storage margins of the second terminals and the first data volume of the to-be-transferred data.

In some embodiments, the determining the first data scheduling plan according to the first data volume of to-be-transferred data of the first terminal and the terminal information received from the server, includes: acquiring the terminal information from the server, and determining the first data scheduling plan according to the internal storage margin of each terminal in the terminal information and the first data volume of the to-be-transferred data in response to the data scheduling request initiated by the first terminal and indicating that the first terminal is physically attacked, in a case where it is detected that the first terminal is physically attacked.

In some embodiments, the determining the first data scheduling plan according to the internal storage margin of each terminal in the terminal information and the first data volume of the to-be-transferred data, includes: selecting a terminal with the internal storage margin greater than or equal to a second preset threshold from the terminals according to the internal storage margin of each terminal in the terminal information, as the second terminal to receive the to-be-transferred data; determining a data transmission time length of each second terminal according to a data transmission speed of each second terminal and the first data volume of the to-be-transferred data, wherein the data transmission time lengths of the second terminals are the same; determining whether a data volume to be received by the second terminal exceeds the internal storage margin of the second terminal according to the data transmission speed and the data transmission time length of each second terminal; and determining the data volume to be received by the second terminal as the second data volume of the to-be-transferred data to be received in response that the data volume to be received by any second terminal does not exceed the internal storage margin of the second terminal.

In some embodiments, the data transmission method further includes: determining, in a case where the data volume to be received by a second terminal exceeds the internal storage margin of the second terminal, the second terminal as a target second terminal, and determining the second data volume receivable by the target second terminal as the internal storage margin of the target second terminal; and for remaining second terminals other than the target second terminal, returning to execute the determining the data transmission time length of each second terminal according to the data transmission speed of each second terminal and the first data volume of the to-be-transferred data, until the data volume to be received by each of the remaining second terminals does not exceed the internal storage margin of each of the remaining second terminals, and determining the second data volumes of the to-be-transferred data receivable by the remaining second terminals.

In a third aspect, an embodiment of the present disclosure further provides a data transmission device, including: a server configured to determine, in response to a data scheduling request sent by a first terminal, a first data scheduling plan of the first terminal according to a first data volume of a to-be-transferred data of the first terminal carried in the data scheduling request and terminal information stored in the server, and send the first data scheduling plan to the first terminal, wherein the terminal information comprises information of each of terminals within a signal coverage of a gateway, the first data scheduling plan comprises information of each of second terminals and a second data volume receivable by each second terminal, the first terminal is a terminal among the terminals to transfer the to-be-transferred data therein within the signal coverage of the gateway, and the second terminal is a terminal among the terminals different from the first terminal within the signal coverage of the gateway; and the first terminal configured to receive the first data scheduling plan, and divide the to-be-transferred data with the first data volume into a plurality of pieces of sub-data according to the second data volume receivable by each second terminal, to obtain each piece of sub-data; and send each piece of sub-data to the second terminal.

In a fourth aspect, an embodiment of the present disclosure further provides a data transmission device, including: a first processing component configured to determine, in response to a data scheduling request, a first data scheduling plan according to a first data volume of a to-be-transferred data of a first terminal and terminal information received from a server, wherein the terminal information comprises information of each of terminals within a signal coverage of the gateway, the first data scheduling plan comprises information of each of second terminals and a second data volume receivable by each second terminal, the second terminal is a terminal among the terminals different from the first terminal within the signal coverage of the gateway, and the first terminal is a terminal among the terminals which sends the data scheduling request within the signal coverage of the gateway; a second processing component configured to divide the to-be-transferred data with the first data volume into a plurality of pieces according to the second data volume receivable by each second terminal to obtain each piece of sub-data; and a sending module configured to send each piece of the sub-data to the corresponding second terminal respectively.

In a fifth aspect, an embodiment of the present disclosure further provides a computer device, including: a processor, a memory and a bus, wherein the memory stores machine-readable instructions executable by the processor, the processor and the memory are communicated with each other over the bus when the computer device is running, and the machine-readable instructions, when executed by the processor, cause the processor to perform steps of the data transmission method in any one of the embodiments.

In a sixth aspect, an embodiment of the present disclosure further provides a non-transitory computer readable storage medium storing a computer program thereon, wherein the computer program, when is executed by a processor, cause the processor to perform steps of the data transmission method in any one of the embodiments.

### BRIEF DESCRIPTION OF DRAWINGS

FIG. 1 is a flowchart of a data transmission method according to an embodiment of the present disclosure;

FIG. 2a is a schematic flowchart illustrating a process of creating a first data scheduling plan when an internal storage of a first terminal is exhausted according to an embodiment of the present disclosure;

FIG. 2b is a flowchart illustrating an exemplary process of creating a first data scheduling plan according to an embodiment of the present disclosure;

FIG. 3a is a schematic flowchart illustrating a process of creating a first data scheduling plan when a first terminal is physically attacked according to an embodiment of the present disclosure;

FIG. 3b is a flowchart of another exemplary process for creating a first data scheduling plan according to an embodiment of the present disclosure;

FIG. 4 is a schematic diagram of a network transmission architecture according to an embodiment of the present disclosure;

FIG. 5 is a specific flowchart of a data transmission method according to an embodiment of the present disclosure;

FIG. 6 is a specific schematic flowchart of a data transmission method according to an embodiment of the present disclosure; and

FIG. 7 is a schematic diagram of a structure of a computer device according to an embodiment of the present disclosure.

### DETAIL DESCRIPTION OF EMBODIMENTS

To make the objects, technical solutions and advantages of embodiments of the present disclosure more apparent, the technical solutions of the embodiments of the present disclosure will be described clearly and completely with reference to the drawings accompanying the embodiments of the present disclosure, and it is obvious that the described embodiments are only a part of embodiments of the present disclosure, not all embodiments of the present disclosure. Generally, the components of the embodiments of the present disclosure, as described and illustrated in the figures herein, could be arranged and designed in a wide variety of different configurations. Thus, the following detailed description of the embodiments of the present disclosure, provided in the accompanying drawings, is not intended to limit the scope of the present disclosure, as claimed, but is merely representative of selected embodiments of the present disclosure. All other embodiments, which can be derived by one of ordinary skill in the art from the embodiments of the present disclosure without making any inventive effort, shall fall within the protection scope of the present disclosure.

Unless defined otherwise, technical or scientific terms used herein shall have the ordinary meaning as understood by one of ordinary skill in the art to which this disclosure belongs. The use of “first”, “second”, and the like in this disclosure is not intended to indicate any order, quantity, or importance, but rather is used for distinguishing one element from another. Further, the use of the terms “a”, “an”, “the”, or the like does not denote a limitation of quantity, but rather denotes the presence of at least one. The word “include”, “comprise”, or the like, means that the element or item preceding the word contains the element or item listed after the word and its equivalent, but does not exclude the presence of other elements or items.

The phrase “a plurality of”, “multiple” or “several” used in this disclosure means two or more. The phrase “and/or” describes the association relationship of the associated objects, indicating that there may be three relationships, for example, A and/or B may indicates the following three cases: A exists alone, A and B both exist, and B exists alone. The character “/” generally indicates that the preceding and following associated objects are in an “or” relationship.

In the related art, the following processing manners are generally adopted to protect user privacy data locally stored in a smart terminal: 1) a security module mechanism, and 2) a network backup mechanism. The security module mechanism 1) means that a separate encryption storage device is arranged in the terminal to prevent the leakage of confidential data. However, the encryption storage device generally has a limited storage capacity, which cannot ensure the long-time closed operation of the encryption storage device. At present, problems are solved mostly through regular deletion, manual replacement or regular uploading, and such the operation process is complicated. In addition, the encryption storage device is integrated in the terminal, which cannot deal with an emergency such as a sudden fire or a sudden high-level network attack, and in these cases, the data cannot be quickly transferred. The network backup mechanism 2) means that the data collected by the terminal is immediately uploaded to a cloud and the locally stored data is cleared. However, this process requires that the date is continually uploading by the smart device, which increases the device loss. In order to realize such the process, the smart device necessarily has higher performances, and a data packet is transmitted in the network at an excessively high frequency, which increases the risk of data stealing. In addition, in general, the terminal and the cloud are communicated to each other through an https protocol, which is slow in data transmission speed and wastes bandwidth (the bandwidth is in direct proportion to the cost), thereby increasing the transmission cost. In addition, the data is stored in the cloud, which causes inconvenience in local use by the terminal.

In view of this, an embodiment of the present disclosure provides a data transmission method that substantially obviates one or more of the problems due to limitations and disadvantages of the related art. Specifically, in the embodiment of the present disclosure, the data transmission method includes: determining, by a server, a first data scheduling plan of a first terminal according to a first data volume of a to-be-transferred data of a first terminal carried in a data scheduling request and terminal information stored in the server, in response to a data scheduling request sent by the first terminal, and sending the first data scheduling plan to the first terminal, wherein the terminal information includes information of each terminal within a signal coverage of a gateway; the first data scheduling plan includes information of each second terminal and a second data volume receivable by each second terminal; the first terminal is a terminal to transfer the to-be-transferred data within the signal coverage of the gateway, and the second terminal is a terminal different from the first terminal within the signal coverage of the gateway; and receiving, by the first terminal, the first data scheduling plan; dividing the to-be-transferred data having the first data volume into a plurality of pieces of sub-data according to the second data volume receivable by each second terminal, to obtain each piece of sub-data, and sending the each piece of sub-data to the second terminal.

A local storage mechanism is adopted in the embodiment of the present disclosure. The “local” herein refers to a mimicry internal storage space formed by terminals in a signal coverage of the same gateway. The to-be-transferred data in a certain first terminal within any one gateway coverage is stored in a local internal storage space of a second terminal within the gateway coverage, so that the distributed storage of the to-be-transferred data is achieved. A speed of the data transmission among the terminals is higher than that between the terminal and the cloud, and therefore fast backup of the data can be achieved through the local storage. In addition, compared with the traditional technology, in the embodiments of the present disclosure, the encryption storage device is unnecessarily provided, the backup data is unnecessarily continually uploaded to the terminal, and the risk that the network transmission data is stolen is reduced.

The data transmission method provided by an embodiment of the present disclosure is described below in detail, and an executing entity of the data transmission method may be a data transmission device with a computing capability, and integrated with a server and at least one terminal in a signal coverage of a gateway. The server may be a gateway, a cloud, or an advanced terminal. The advanced terminal so-called refers to a terminal with a high computing capability.

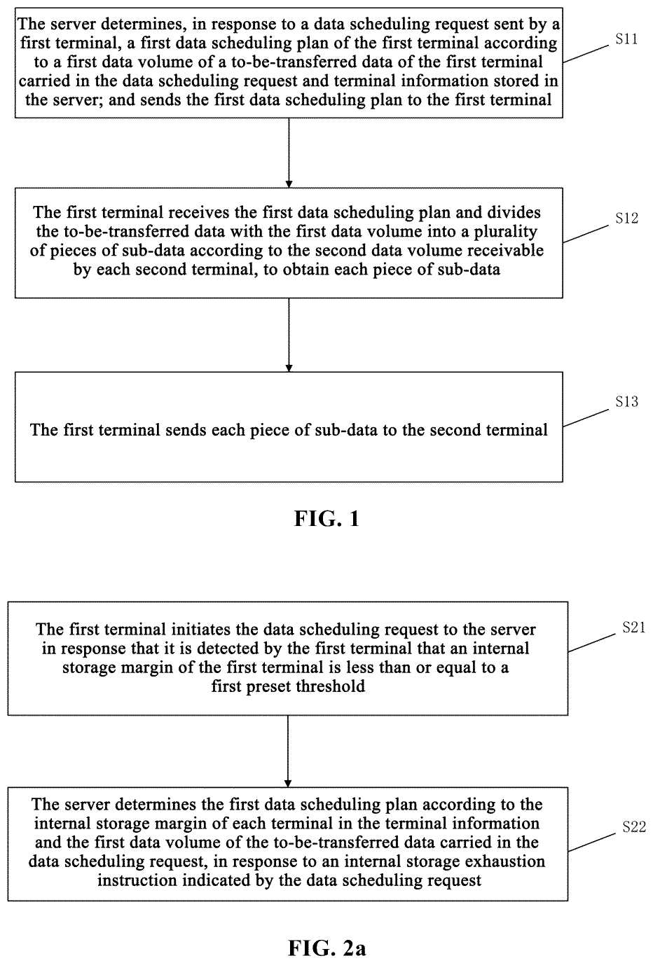

The data transmission method provided by the present disclosure includes a data transfer process and a data recovery process. The data transfer process will be described in detail first. FIG. 1 is a flowchart of a data transmission method according to an embodiment of the present disclosure. As shown in FIG. 1, the method includes steps S11 to S12:

The step S11 includes determining, by a server, a first data scheduling plan of a first terminal according to a first data volume of a to-be-transferred data of a first terminal carried in a data scheduling request and terminal information stored in the server, in response to the data scheduling request sent by the first terminal, and sending the first data scheduling plan to the first terminal.

In this step, the terminal information includes information of each terminal within a signal coverage of a gateway. The information of the terminal includes, for example, internet protocol (IP) of the terminal, a remaining internal storage space, an occupancy rate of redundant space (that is, a percentage of the redundant space in the total space of the internal storage), a standby port (that is, for transferring data), and read-write functions (different terminals have different read-write functions; a fixed read-write function is provided for any terminal and used for reading to-be-transferred data in the internal storage or writing the to-be-transferred data into the internal storage), and the like.

In this step, the first data scheduling plan includes information of each second terminal and a second data volume receivable by each second terminal; the first terminal is a terminal to transfer the to-be-transferred data therein with the signal coverage of the gateway (also referred to as gateway coverage), and the second terminal is a terminal different from the first terminal within the signal coverage of the gateway.

In the embodiment of the present disclosure, the first data scheduling plan of the first terminal is generated by using the server with a strong performance, which can avoid using an edge calculation mode, and reduce the performance requirement on an edge device (a terminal within the gateway coverage).

In specific implementation, the server responds to the data scheduling request sent by the first terminal and carried with the first data volume of the to-be-transferred data of the first terminal; the server may create the first data scheduling plan of the first terminal according to the first data volume and the remaining internal storage space of each terminal in the stored terminal information, so that the first terminal transfers the data according to the first data scheduling plan. Here, the process of generating the first data scheduling plan may specifically include distributively storing the to-be-transferred data with the first data volume in different terminals (which may be all or at least some terminals within the gateway coverage) according to the remaining internal storage space of each terminal, and the terminal to receive the to-be-transferred data is selected as the second terminal.

For example, the first data volume of the to-be-transferred data of the first terminal is 100M, the remaining internal storage spaces of other terminals (such as terminals A, B and C) other than the first terminal within the gateway coverage are 25M, 50M and 125M, respectively. It should be noted that in order to avoid affecting the operation of the terminals in the internal storage exhaustion, in general, it is specified in the system that the internal storage necessarily has a fixed remaining space of 20%, and therefore, internal storage margins of the terminals A, B and C (i.e. a space of the internal storage used for receiving data) are 20M, 40M and 100M, respectively. At this time, the second terminal may be selected as needed. For example, the terminals B and C, may be selected as the second terminals, and the mimicry internal storage space of 40M+100M is used for storing the to-be-transferred data of 100M, to generate the first data scheduling plan, which at least includes the IP information of each second terminal, the standby port of each second terminal and the second data volume receivable by each second terminal (for example, the second data volume receivable by the terminal B is 20M, and the second data volume receivable by the terminal C is 80M). Alternatively, the terminal A, the terminal B, and the terminal C may be selected as the second terminals, and the mimicry internal storage space of 20M+40M+100M may be used to store the to-be-transferred data of 100M. Alternatively, only the terminal C may be selected as the second terminal, and the mimicry internal storage space of 100M may be used to store the to-be-transferred data of 100M. In the embodiment of the present disclosure, the second terminal passively receiving the to-be-transferred data may be selected according to actual needs, which is not particularly limited in the present disclosure.

Here, the first terminal is a terminal to transfer the to-be-transferred data therein within the gateway coverage, and the second terminal is a terminal different from the first terminal in the gateway coverage. It should be noted that the first terminal is not a fixed terminal within the gateway coverage specified by the system, but for ease of understanding, a terminal to transfer the data is distinguished by using terms “first” and “second” from a terminal to subsequently receive the data, and the terms “first” and “second” should not be taken as limiting the scope of protection of the embodiments of the present disclosure.

For example, when the server is a cloud, a publication and a connection may be realized between the cloud and the terminal through a Message Queuing Telemetry Transport (MQTT) protocol. The MQTT protocol is a publish/subscribe paradigm based messaging protocol under the ISO standard. The MQTT works on Transmission Control Protocol/Internet Protocol (TCP/IP), and is a publish/subscribe messaging protocol designed for remote devices with low hardware performance and for the case of bad network conditions. The MQTT protocol is a client-server based message publish/subscribe transport protocol. The MQTT protocol is lightweight, simple, open, and easy to implement. It should be noted that the data volume for the MQTT protocol is small, and the to-be-transferred data (for example, data such as pictures and the like) cannot be transmitted through the MQTT protocol, and the MQTT protocol only carries the first data scheduling plan, which has a data volume far smaller than that of the to-be-transferred data such as pictures and the like.

The step S12 includes receiving, by the first terminal, the first data scheduling plan, and dividing the to-be-transferred data with the first data volume into a plurality of pieces of sub-data according to the second data volume receivable by each second terminal, to obtain each piece of sub-data.

Continuing the above example, the first terminal determines, according to the received first data scheduling plan, that the second data volume receivable by the terminal B is 20M, and the second data volume receivable by the terminal C is 80M, and divides the to-be-transferred data of 100M into two pieces, where a data volume of one piece of sub-data is 20M, and a data volume of the other piece of sub-data is 80M.

The step S13 includes sending, by the first terminal, each piece of sub-data to the second terminal.

Continuing the above example, the first terminal may send the sub-data of 20M to the terminal B according to the IP information and the standby port of the terminal B, and send the sub-data of 80M to the terminal C according to the IP information and the standby port of the terminal C.

In some embodiments, a communication mode between the first terminal and the second terminal may be socket transmission, which is a transmission mode in which the data may be quickly transmitted in a local area network, but the socket transmission is not a communication protocol, and refers to a communication mode through an IP and a port of a terminal. For example, the first terminal and the second terminal may be communicated with each other over User Datagram Protocol (UDP), which is faster than the TCP/IP communication. For example, the first terminal and the second terminal may be communicated with each other over the TCP/IP, which is more reliable than the UDP. Preferably, the UDP protocol is used for the transmission, and it needs to establish a stable connection for the TCP/IP protocol, which is time-consuming. An establishment speed and a transmission speed for the UDP protocol are high, and the application in the local area network is also reliable.

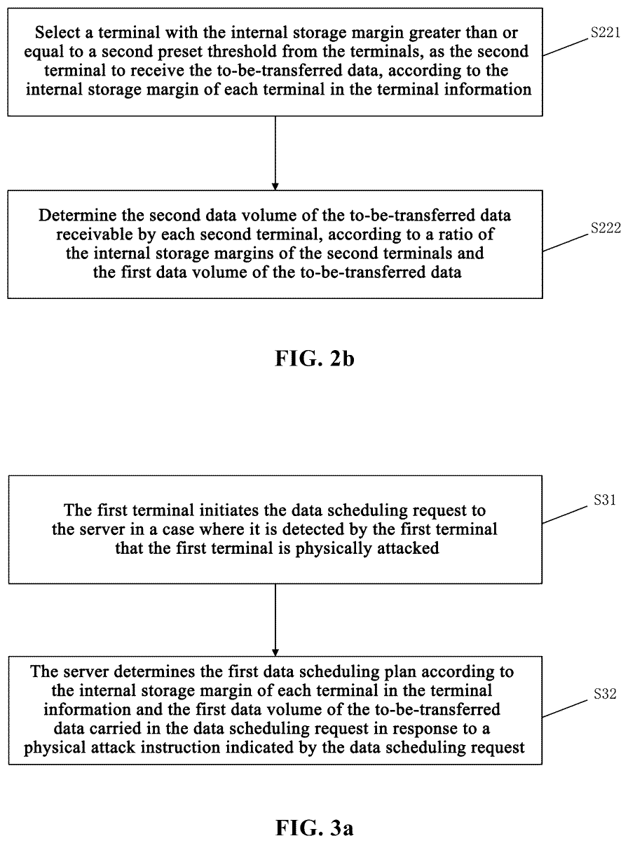

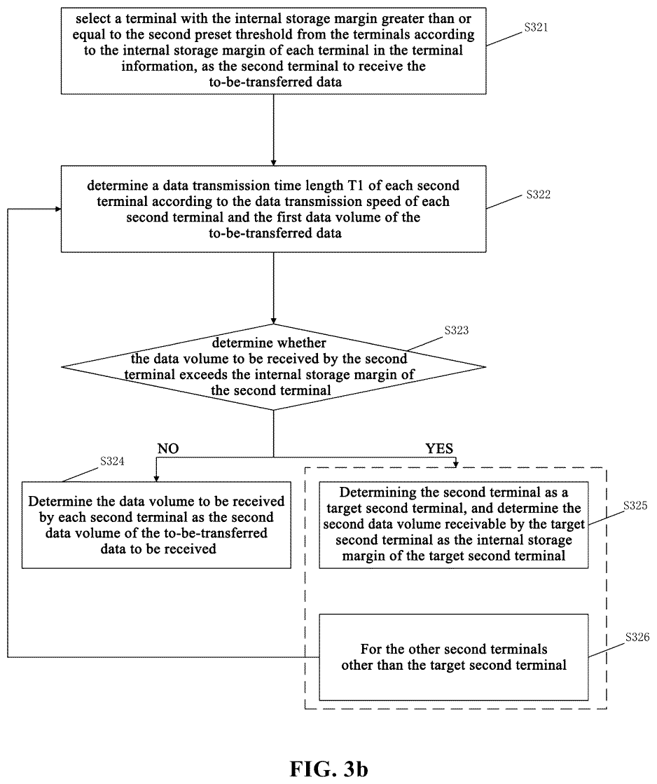

In general, the first terminal initiates the data scheduling request in different scenarios, and the server generates the first data scheduling plan corresponding to the scenario indicated by the data scheduling request according to the scenario indicated by the data scheduling request. Different scenarios are shown in FIGS. 2 and 3 below.

In some embodiments, FIG. 2a is a schematic flowchart illustrating a process of creating a first data scheduling plan when an internal storage of a first terminal is exhausted according to an embodiment of the present disclosure. As shown in FIG. 2a, the method includes steps S21 and S22:

The step S21 includes initiating, by the first terminal, the data scheduling request to the server in a case where it is detected by the first terminal that an internal storage margin of the first terminal is less than or equal to a first preset threshold.

The first terminal may automatically monitor the internal storage margin of the first terminal, and when the internal storage margin is less than or equal to the first preset threshold, it indicates that the internal storage of the first terminal is about to be exhausted at this time, for example, there is no margin to store other data, or the first terminal were unable to operate due to storing other data. In this case, the first terminal is required to actively initiate the data scheduling request to transfer the data in the internal storage to other terminals. It should be noted that the to-be-transferred data of the first terminal may be set to be all data or part of sensitive data (for example, privacy data of a user, etc.) in the internal storage according to actual requirements.

The step S22 includes determining, by the server, the first data scheduling plan according to the internal storage margin of each terminal in the terminal information and the first data volume of the to-be-transferred data carried in the data scheduling request, in response to an internal storage exhaustion instruction indicated by the data scheduling request.

It should be noted that the terminal selects different data transfer strategies in different situations. In a case where the internal storage exhaustion instruction indicates the requirement for data emergency cache is not high, a balanced transfer strategy that consumes a little bit more time but has a less consumption for the whole system may be selected. At this time, the server starts a load balancing algorithm in response to the internal storage exhaustion instruction, where the load balancing is understood to mean that the second terminal with the greater internal storage margin can receive the greater second data volume according to a size of the internal storage margin of the second terminal, and vice versa. Specifically, the load balancing algorithm may create, according to the internal storage margin of each terminal in the terminal information and the first data volume of the to-be-transferred data carried in the data scheduling request, a scheme where the second terminals store the to-be-transferred data in a balanced manner according to the size of the internal storage margin, so as to generate the first data scheduling plan.

For example, FIG. 2b is a flowchart illustrating an exemplary process of creating a first data scheduling plan according to an embodiment of the present disclosure. As shown in FIG. 2b, the process includes steps S221 and S222.

The step S221 includes selecting a terminal with the internal storage margin greater than or equal to a second preset threshold from the terminals according to the internal storage margin of each terminal in the terminal information, as the second terminal to receive the to-be-transferred data.

In some scenarios, for example, the first data volume of the to-be-transferred data is great, the internal storage margins of the terminals are not always sufficient. If some terminals with low internal storage margins are used as the second terminals to receive the to-be-transferred data, not only a lot of to-be-transferred data cannot be stored, that is, the storage efficiency is reduced, but also additional consumption of the system is increased. Therefore, in the embodiment of the present disclosure, the second terminals meeting the requirement are dynamically selected from the terminals for receiving the to-be-transferred data according to the internal storage margin of each terminal in the terminal information, so that the data transfer efficiency can be improved, and the system consumption can be reduced.

It should be noted that the second preset threshold may be set according to actual requirements. For example, if the first data volume of the to-be-transferred data is great, the second preset threshold is relatively high. Conversely, if the first data volume of the to-be-transferred data is small, the second preset threshold is relatively small, and may even be 0, which is not specifically limited in the embodiment of the present disclosure.

The step S222 includes determining the second data volume of the to-be-transferred data receivable by each second terminal, according to a ratio of the internal storage margins of the second terminals and the first data volume of the to-be-transferred data.

For example, the first data volume of the to-be-transferred data of the first terminal is 100M, and the second terminal includes a terminal B and a terminal C, where the remaining internal storage space of the terminal B is 50M, and the remaining internal storage space of the terminal C is 125M; the internal storage margin of the terminal B is 40M, and the internal storage margin of the terminal C is 100M. A ratio of the internal storage margin of the terminal B to the internal storage margin of the terminal C is 2:5. The first data scheduling plan for load balancing may be created according to the ratio (for example 2:5 in this case) of the internal storage margins of the second terminals. For example, the to-be-transferred data of 100M is divided into two pieces, where a second data volume receivable by the terminal B is 100×2/(2+5), which is approximately 29M; the second data volume receivable by the terminal C is 100×5/(2+5), which is approximately 71M.

The to-be-transferred data is stored on different second terminals in a distributed manner by using the load balancing mode in the embodiment of the present disclosure, which improves the utilization of the mimicry internal storage space as much as possible without influencing the operating efficiency of the second terminals.

The load balancing is only one method for generating the first data scheduling plan by the server in response to the internal storage exhaustion instruction. Alternatively, other different data scheduling plans may be created in response to the internal storage exhaustion instruction according to the internal storage margin of each terminal in the terminal information and the first data volume of the to-be-transferred data carried in the data scheduling request, as long as it is ensured that the to-be-transferred data in the first terminal needs to be transferred to other terminals, and the internal storage of the first terminal is released.

In some embodiments, the first terminal initiates the data scheduling request to the server when detecting that the first terminal is attacked by software. A software attack is here understood to mean that sensitive data, such as private data of the user or the like, is called by an illegal access request. The server determines the first data scheduling plan according to the internal storage margin of each terminal in the terminal information and the first data volume of the to-be-transferred data carried in the data scheduling request, in response to a software attack instruction indicated by the data scheduling request.

It should be noted that the requirement for the data emergency cache is not high in the software attack, and therefore, a balanced transfer strategy, that is, the load balancing strategy, that consumes a little bit more time but has a less consumption for the whole system may be selected. The process of specifically creating the first data scheduling plan may refer to steps S221 and S222, and repeated parts are not described again.

In some embodiments, when the load balancing strategy is used to transfer the data, the data transmission is not urgent, and therefore, the first terminal and the second terminal may be communicated with each other through the transmission control protocol TCP or the internet protocol IP, so that the data transmission is more reliable.

In some embodiments, FIG. 3a is a schematic flowchart illustrating a process of creating a first data scheduling plan when a first terminal is physically attacked according to an embodiment of the present disclosure. As shown in FIG. 3a, the process includes steps S31 and S32:

The step S31 includes initiating, by the first terminal, the data scheduling request to the server in a case where it is detected by the first terminal that the first terminal is physically attacked.

In this step, the physical attack may be understood as that the hardware of the first terminal is attacked or damaged. Specifically, whether the first terminal is physically attacked may be determined by using feedback signals form an illuminance sensor, a humidity sensor, or a proximity sensor or the like on the first terminal.

At this time, in order to ensure the data integrity, the to-be-transferred data is all data in the internal storage of the first terminal.

The step S32 includes determining, by the server, the first data scheduling plan according to the internal storage margin of each terminal in the terminal information and the first data volume of the to-be-transferred data carried in the data scheduling request in response to a physical attack instruction indicated by the data scheduling request.

It should be noted that different data transfer strategies are selected according to different situations of the terminal. A fast transfer strategy with short time consumption may be selected in a case where the requirement on the data emergency cache is higher in the situation where the hardware is attacked or damaged. At the moment, the server starts a fast transfer algorithm in response to the physical attack instruction, and creates the first data scheduling plan for the data transfer with shortest time consumption according to the internal storage margin of each terminal in the terminal information and the first data volume of the to-be-transferred data carried in the data scheduling request. The fast transfer is understood to take the shortest time to transfer the to-be-transferred data to the second terminal.

For example, different second terminals have different data transmission speeds, and therefore, it takes different time lengths for different second terminals to receive sub-data of the same data volume. According to the load balancing scheme, some second terminals may receive and store the sub-data soon, and wait for some other second terminals with slower data transmission speeds, thereby affecting the data transfer speed, which is not beneficial to the data backup of the first terminal subjected to the physical attack. Therefore, for the first terminal subjected to the physical attack, the server needs to create the first data scheduling plan for fast transferring data.

FIG. 3b is a flowchart of another exemplary method for creating a first data scheduling plan according to an embodiment of the present disclosure. As shown in FIG. 3b, the method includes steps S321 to S326:

The step S321 includes selecting a terminal with the internal storage margin greater than or equal to the second preset threshold from the terminals according to the internal storage margin of each terminal in the terminal information, as the second terminal to receive the to-be-transferred data.

In some scenarios, for example, the first data volume of the to-be-transferred data is great, the internal storage margins of the terminals are not always sufficient. If some terminals with low internal storage margins are used as the second terminals to receive the to-be-transferred data, not only a lot of the to-be-transferred data cannot be stored, that is, the storage efficiency is reduced, but also additional consumption of the system is increased. Therefore, in the embodiment of the present disclosure, the second terminals meeting the requirement are dynamically selected from the terminals for receiving the to-be-transferred data according to the internal storage margin of each terminal in the terminal information, so that the data transfer efficiency can be improved, and the system consumption can be reduced.

It should be noted that the second preset threshold may be set according to actual requirements. For example, if the first data volume of the to-be-transferred data is great, the second preset threshold is relatively high. Conversely, if the first data volume of the to-be-transferred data is small, the second preset threshold is relatively small, and may even be 0, which is not specifically limited in the embodiment of the present disclosure.

The step S322 includes determining a data transmission time length T1 of each second terminal according to the data transmission speed of each second terminal and the first data volume of the to-be-transferred data.

The data transmission time lengths T1 of the second terminals are the same.

For example, it is known that a data transmission speed of the second terminal A is Vi, a data transmission speed of the second terminal B is Vj, a data transmission speed of the second terminal C is Vt, and the first data volume of the to-be-transferred data is Q, so that the data transmission time length of each second terminal is determined as

$$T 1 = Q / ( Vi + Vj + Vt ) .$$

The step S323 includes determining whether the data volume to be received by the second terminal exceeds the internal storage margin of the second terminal according to the data transmission speed and the data transmission time length of each second terminal. If the data volume to be received by any second terminal does not exceed the internal storage margin of the second terminal, step S324 is executed; if the data volume to be received by any second terminal exceeds the internal storage margin of the second terminal, step S325 is executed.

Continuing the above example, it is known that the internal storage margin of the second terminal A is X1, the data transfer speed of the second terminal B is X2, the data transfer speed of the second terminal C is X3, the data volume to be received by the second terminal A is Vi×T1, the data volume to be received by the second terminal B is Vj×T1, and the data volume to be received by the second terminal C is Vt×T1.

It should be noted that the data volume to be received by the second terminal is not the second data volume for the sub-data to be stored actually, but is a predetermined data volume that may be stored quickly in theory, and may or may not exceed the internal storage margin of the corresponding second terminal.

The step S324 includes determining the data volume to be received by each second terminal as the second data volume of to-be-transferred data to be received in a case where the data volume to be received by any second terminal does not exceed the internal storage margin of the second terminal.

Continuing the above example, in the case of Vi×T1≤X1, Vj×T1≤X2, and Vt×T1≤X3, it is determined that the second data volume of the second terminal A is Vi×T1, the second data volume of the second terminal B is Vj×T1, and the second data volume of the second terminal C is Vt×T1.

The step S325 includes determining, in a case where the data volume to be received by a second terminal exceeds the internal storage margin of the second terminal, the second terminal as a target second terminal, and determining the second data volume receivable by the target second terminal as the internal storage margin of the target second terminal.

For example, if Vi×T1>X1, Vj×T1≤X2, and Vt×T1≤X3, it is determined that the second terminal A as the target second terminal, and the second terminals B and C are the second terminals other than the target second terminal. At this time, it is determined that the second data volume, that is, X1, receivable by the target second terminal as the internal storage margin of the target second terminal.

The step S326 includes for the other second terminals other than the target second terminal, returning to execute step S322, and determining the second data volumes of the to-be-transferred data receivable by the other second terminals, until the data volume to be received by each of the other second terminals does not exceed the internal storage margin of the other second terminal.

When returning to execute step S322, the other second terminals are equivalent to the second terminals in step S322, and the specific principle of determining the data transmission time length is the same. In specific implementation, the data transmission time lengths T2 of the other second terminals may be determined according to the internal storage margin of the target second terminal, the data transmission speeds of the other second terminals, and the first data volume of the to-be-transferred data; the data transmission time lengths T2 of the other second terminals are the same.

Continuing the above example, the internal storage margin X1 of the target second terminal, the data transmission speed Vj of the second terminal B, the data transmission speed Vt of the second terminal C, and the first data volume Q of the to-be-transferred data are known, and it is determined that the data transmission time lengths of the other second terminals is T2=(Q−X1)/(Vj+Vt). In this way, the backup of the to-be-transferred data can be still completed within the shortest time.

In the case of Vj×T2≤X2 and Vt×T2X3, it is determined that the second data volume of the second terminal A is X1, the second data volume of the second terminal B is Vj×T2, and the second data volume of the second terminal C is Vt×T2.

In the above steps S321 to S326, the server may reduce a data receiving burden of the second terminal with a low network speed by creating the first data scheduling plan for fast transferring data, and increase the data transfer speed.

In some embodiments, when adopting the fast transfer strategy in the above embodiments, the first terminal and the second terminal may be communicated with each other via UDP, which is faster than TCP/IP communication, so as to further improve the data transfer speed.

In some embodiments, the first terminal transfers the data stored in internal storage, and in an actual application scenario, the data transferred by the first terminal subjected to the physical attack may also be recovered after the first terminal is repaired or replaced by an equivalent terminal. Therefore, the transferred sub-data needs to be marked to mark the first terminal to which the sub-data belongs, the splicing sequence during recovery, and the like.

The step S13 specifically includes steps S131 and S132.

The step S131 includes for each piece of sub-data, adding a group of first preset identifiers before the sub-data, and adding a group of first preset identifiers after the sub-data to obtain a data packet containing the preset identifiers and the sub-data.

For example, the first preset identifier includes a second preset identifier, an IP number of a first terminal, and a splicing sequence number of corresponding sub-data. The second preset identifier is an identifier for representing the first data scheduling plan. For example, the first preset identifier is XXXYYYZZZ, where “XXX” represents the second preset identifier, “YYY” represents an IP number of the first terminal, and “ZZZ” represents the splicing sequence number of the corresponding sub-data, and GGG represents the sub-data, thereby the resulting data packet is a set of data XXXYYYZZZGGGXXXYYYZZZ.

The first preset identifier is added to each piece of sub-data before being transferred, the different first preset identifiers are added to different sub-data. Specifically, the first preset identifiers added to different sub-data indicate different splicing sequence numbers, the splicing sequence numbers of the sub-data are sequentially arranged according to a sequence of dividing the to-be-transferred data, a splicing sequence number of the sub-data in a first section is 01, a splicing sequence number of the sub-data in a second section is 02 and . . . , and a splicing sequence number of the sub-data in an nth section is n; Alternatively, the splicing sequence number of the sub-data in the nth section is 01, the splicing sequence number of the sub-data in the (n−1)th section is 02, . . . , and the splicing sequence number of the sub-data in the first section is n. In the subsequent data recovery, the sub-data only needs to be sequentially spliced according to the sequence of the splicing sequence numbers to obtain complete recovery data (i.e., the to-be-transferred data in the data transfer).

The step S132 includes respectively sending the data packets corresponding to the pieces of sub-data to the corresponding second terminals.

Here, the first terminal sends the data packets corresponding to the pieces of sub-data to the corresponding second terminals, respectively. In the subsequent data recovery, the second terminal may retrieve the data packet for which the data is requested to be recovered according to the first preset identifier carried in the data packet, and feed the data packet back to the first terminal.

The data transmission method provided by the present disclosure further includes a data recovery process. That is, the first terminal requests to recover the data transferred in the transfer process to the internal storage. In one case, after the second terminal receives the data packet from the first terminal, the data packet is not scheduled until the data packet is not recovered. In another case, in order to satisfy the balance of the internal storage margins of the terminals within the signal coverage of the gateway and to realize the rapid transfer of the to-be-transferred data, the mimicry internal storage spaces formed by the terminals are updated irregularly, the internal storage margins of the terminals are changed after the update, and the data in the internal storage of the terminal is also adjusted. For example, the data packet of the first terminal is transferred to the second terminal A. However, the second terminal A, as a terminal to transfer data, is likely to transfer partial data of the data packet of the first terminal to the internal storage of another terminal (not the first terminal nor the second terminal) within the coverage of the gateway for storage, so that a phenomenon of “nesting doll” of data occurs. For example, there are the first terminal, the second terminal S1, the second terminal S2 and the second terminal S3, the first terminal transfers different sub-data to the second terminal S1, the second terminal S2 and the second terminal S3, respectively; the second terminal S1 transfers its own partial data and partial sub-data of the first terminal to the second terminal S2, so that the second terminal S2 stores the partial sub-data of the first terminal as well as the partial data of the second terminal S2. Therefore, the phenomenon of “nesting doll” of data occurs.

In some embodiments, for the case that the second terminal does not schedule the received data packet, as shown in FIG. 1, the method specifically includes steps S41 to S43:

The step S41 includes sending, by the first terminal, a first data recovery request to each terminal within the signal coverage of the gateway, so that each terminal determines whether the terminal is a terminal storing the data packet of the first terminal in response to the first data recovery request.

Here, the first terminal broadcasts the first data recovery request within the signal coverage of the gateway, each terminal within the signal coverage of the gateway responds to the first data recovery request. Each terminal determines whether the data packet matched with the second preset identifier is stored in the internal storage of the terminal according to the second preset identifier carried in the first data recovery request. Specifically, it may be detected whether the second preset identifier carried in the first data recovery request matches with the second preset identifier included in the first preset identifier of the data packet, and if so, the terminal is a second terminal that receives the data packet of the first terminal. If not, the terminal has not stored the data packet of the first terminal.

The step S42 includes determining, by the second terminal, a data packet matched with the second preset identifier carried by the first data recovery request according to the first preset identifier in the data packet in response to the first data recovery request, and sending the data packet to the first terminal.

Because the second terminal stores the data packet, the second terminal may retrieve the data packet matched with the first preset identifier according to the first preset identifier in the data packet in response to the first data recovery request, and send the data packet to the first terminal.

The second preset identifier is an identifier representing the first data scheduling plan, and may include a serial number (SN) of the first terminal that uses the first data scheduling plan, a system timestamp for generating the first data scheduling plan, and the number of times that the first terminal initiates the data scheduling request.

The step S43 includes receiving, by the first terminal, the data packets sent by the second terminals, and splicing the sub-data in the data packets according to the splicing sequence numbers indicated by the first preset identifiers in the data packets to obtain the recovered data.

The first terminal may receive data packets sent by different second terminals, and sequentially splice sub-data in the data packets according to the splicing sequence indicated by the splicing sequence numbers in the received data packets to obtain the recovered data, that is, the “to-be-transferred data” transferred in the data transfer.

In some embodiments, for the “nesting doll” of data, the method includes steps S51 to S57.

The step S51 includes sending, by the first terminal, a first data recovery request to each terminal in the gateway coverage and the server, so that each terminal determines whether the terminal is the terminal storing the data packet of the first terminal in response to the first data recovery request.

Here, the first terminal broadcasts the first data recovery request within the signal coverage of the gateway, and each terminal within the signal coverage of the gateway responds to the first data recovery request. Each terminal determines whether the data packet matched with the second preset identifier is stored in the internal storage of the terminal according to the second preset identifier carried in the first data recovery request. Specifically, it may be detected whether the second preset identifier carried in the first data recovery request matches with the second preset identifier included the first preset identifier of the data packet, and if so, the terminal is a second terminal that receives the data packet of the first terminal. If not, the terminal has not stored the data packet of the first terminal.

The step S52 includes determining, by the second terminal, whether the second preset identifier carried by the first data recovery request exists in the data stored in the second terminal in response to the first data recovery request.

The second terminal is a terminal for receiving the data packet transferred by the first terminal. However, the second terminal is likely to transfer the data packet to other terminals, or split the data packet and transfer the data packet to other terminals together with the partial data in the internal storage of the second terminal. Therefore, the data stored in the second terminal may or may not include the data packet of the first terminal. The second terminal may determine whether the data packet of the first terminal exists in the second terminal by the following manner: detecting whether the data in the internal storage of the second terminal has an identifier matched with the second preset identifier carried in the first data recovery request, and if so, the data packet of the first terminal is stored in the second terminal, and then step S55 is executed; otherwise, the data packet of the first terminal does not exist in the data stored in the second terminal, and step S53 is executed.

The second preset identifier is an identifier representing the first data scheduling plan, and may include a serial number (SN) of the first terminal that uses the first data scheduling plan, a system timestamp for generating the first data scheduling plan, and the number of times that the first terminal initiates the data scheduling request. For example, the second preset identifier is 0000012022102715341101, where “000001” represents the SN number of the first terminal, and “20221027153411” represents the system timestamp for generating the first data scheduling plan, including year, month, day, hour, minute, and second, i.e., 15:34:11 (hour:minute:second) of Oct. 27, 2022. And “01” represents that the first terminal initiates the data scheduling request for the first time.

For example, there are the first terminal, the second terminal S1, the second terminal S2 and the second terminal S3, wherein the first terminal transfers data packets with different sub-data into the second terminal S1, the second terminal S2, and the second terminal S3, respectively; the second terminal S1 transfers the partial data of the second terminal S1 and the data packet of the first terminal stored in the second terminal S1 to the second terminal S2. In this case, the data packet of the first terminal does not exist in the second terminal S1, and the second terminal S2 stores both the partial data of the second terminal S1 and the data packet of the first terminal. The second terminal S3 transfers the partial data of the second terminal S3 and the partial data of the data packet of the first terminal stored in the second terminal S3 to other terminal S0 (other than the first terminal and the second terminal). In this case, the partial data of the data packet of the first terminal exists in the second terminal S3 and the other terminal S0 stores both the partial data of the second terminal S3 and the partial data of the data packet of the first terminal.

The step S53 includes initiating a second data recovery request for requesting to recover the self-transferred data (the data transferred by the second terminal), in response to strategy information at the top in a preset strategy queue by the server if the data stored in the second terminal does not have the second preset identifier carried by the first data recovery request.

Theoretically, the second terminal should store the data packet of the first terminal. If the data stored in the second terminal does not have the second preset identifier carried in the first data recovery request, the second terminal in this step has already transferred the data packet of the first terminal. The data (including the data of the second terminal and the data of the first terminal) transferred by the second terminal needs to be recovered first, and the process of recovering the data of the first terminal may be then performed. Otherwise, the incomplete data packet of the first terminal stored in other terminals cannot be recovered due to the “nesting doll” of data.

The server stores a data scheduling plan of any terminal and a second preset identifier corresponding to the data scheduling plan. The data scheduling plans are sequentially stored in a plan queue according to system timestamps in the second preset identifiers corresponding to the data scheduling plans. All data scheduling plans generated by the server are stored in the plan queue and are sequentially stored according to the system timestamps in the second preset identifiers corresponding to the data scheduling plans, wherein the data scheduling plans arranged at the top in the plan queue are the latest generated data scheduling plans. In the data recovery, the server broadcasts the data scheduling plans according to the sequence of the data scheduling plans in the plan queue, the broadcast carries the second preset identifiers corresponding to the data scheduling plans, and the SN number in the second preset identifier may represent the terminal requesting to recover the data.

Continuing the above example, the second terminal in this step S53 is the second terminal S1 in the above examples (sub-data of the first terminal does not exist in the second terminal). At this time, the server sends a command of recovering data to the second terminal S1 according to the data scheduling plan currently arranged at the top when the SN number in the second preset identifier corresponding to the data scheduling plan is the SN number of the second terminal S1; the second terminal S1 initiates the second data recovery request to each terminal within the signal coverage of the gateway in response to the command for recovering data, so as to request for recovering the data transferred by the second terminal S1 (i.e. the partial data of the second terminal S1 and the data packet of the first terminal stored in the second terminal S2).

The step S54 includes repeatedly executing the step of “determining whether the second preset identifier carried by the first data recovery request exists in the data stored in the second terminal” in the step S52 in response to the first data recovery request when the data recovery of the second terminal S1 is completed.

Specifically, when the data recovery of the second terminal S1 is completed, in response to the first data recovery request, it is determined whether the second preset identifier carried by the first data recovery request exists in the data stored in the second terminal S1. Since the second terminal S1 has recovered the data packet of the first terminal, there must be data matched with the second preset identifier carried in the first data recovery request, and then proceeding to the step S55.

The step S55 includes determining whether the second preset identifier is packaged by additional identifiers if the second preset identifier carried by the first data recovery request exists in the data stored in the second terminal.

In this step, it is determined whether the second preset identifier is packaged by additional identifiers. If so, step S56 is executed; if not, step S57 is executed.

Continuing the above example, the data stored by the second terminal S1 after the data recovery is completed is, for example, W2-R1-W1-R1-W2, where W2 represents the data of the second terminal S1 itself, W1 represents the sub-data of the first terminal, and R1 represents the first preset identifier corresponding to the first terminal. The second preset identifier carried by the first data recovery request initiated by the first terminal exists in the R1, and there are no additional identifiers in the data W2-R1-W1-R1-W2 other than the first preset identifier R1, so that the first preset identifier R1 is not packaged by additional identifiers, and the second terminal S1 after the data recovery is completed continues to execute step S56.

The step S56 includes sending a data packet corresponding to the second preset identifier to the first terminal if the second preset identifier is not packaged by additional identifiers.

Continuing the above example, the data stored in the second terminal S1 after the data recovery is completed is W2-R-W1-R-W2, other than the first preset identifier R, there is no identifier on an outer side (i.e. a side from R to W2), so the second terminal S1 may send the data packet R-W1-R corresponding to the second preset identifier to the first terminal.

For example, there is partial data of the data packet of the first terminal in the second terminal S3, and therefore, the second terminal S3 performs step S55. The data stored in the second terminal S3 includes the second preset identifier carried by the first data recovery request, and the second terminal S3 determines whether the second preset identifier is packaged by additional identifiers. Since the second terminal S3 does not receive data of other terminals, it is detected that the second preset identifier is not packaged by additional identifiers, and the step S56 is sequentially performed.

The step S57 includes monitoring, by the second terminal, whether the terminals corresponding to additional identifiers send a third data recovery request, if the second preset identifier is packaged by additional identifiers, so as to send the data packets corresponding to additional identifiers to the terminals corresponding to the additional identifiers in response to the third data recovery request.

For example, the second terminal S2 stores both the partial data of the second terminal S1 and the data packet of the first terminal. Therefore, the second preset identifier carried by the first data recovery request exists in the data stored in the second terminal S2, the second terminal S2 continues to determine whether the second preset identifier is packaged by additional identifiers. The partial data of the second terminal S1 and the data packet of the first terminal, such as W3-R2-W2-R1-W1-R1-W2-R2-W3, are included in the second terminal S2, where W1 represents sub-data of the first terminal, R1 represents the first preset identifier corresponding to the first terminal, and the second preset identifier carried by the first data recovery request initiated by the first terminal exists in the R1; W2 represents the partial data of the second terminal S1, and R2 represents the first preset identifier corresponding to the second terminal S1; W3 represents the data of the second terminal S2 itself. Therefore, it is determined that the second preset identifier (i.e., the second preset identifier in R1) carried by the first data recovery request initiated by the first terminal in the data W3-R2-W2-R1-W1-R1-W2-R2-W3 of the second terminal S2 is packaged by the additional identifier R2, and R2 corresponds to the second terminal S1. At this time, the second terminal S2 needs to monitor whether the second terminal S1 sends the third data recovery request (that is, in the above embodiment, the second terminal S1 initiates the second data recovery request to each terminal within the signal coverage of the gateway in response to the data recovery command sent by the server), and the second terminal S2 sends the data R2-W2-R1-W1-R1-W2-R2 to the second terminal S1 in response to the second data recovery request of the second terminal S1. It should be noted that here, the terminal corresponding to the additional identifier is the second terminal S1, so that the third data recovery request is also the above second data recovery request; however, the terminal corresponding to the additional identifier may be another terminal, and the third data recovery request is not identical to the second data recovery request. Then, the second terminal S1 splices the data to obtain data W2-R1-W1-R1-W2. The second terminal S1 returns to execute step S52 until the data R1-W1-R1 is sent to the first terminal.

For example, for the other terminal S0, both the partial data of the second terminal S3 and the partial data of the data packet of the first terminal are stored in another terminal S0. Therefore, the data stored in another terminal S0 includes the second preset identifier carried by the first data recovery request, and it continues to determine whether the second preset identifier is packaged by additional identifiers. Both the partial data of the second terminal S3 and the partial data of the data packet of the first terminal, such as W0-R4-W4-R1-W1-R4-W0 are included in the another terminal S0, where W1 represents the sub-data of the first terminal, R1 represents the first preset identifier corresponding to the first terminal, and R1 includes the second preset identifier carried by the first data recovery request initiated by the first terminal; W4 represents the partial data of the second terminal S3, and R4 represents the first preset identifier corresponding to the second terminal S3; W0 represents the data of another terminal S0. Therefore, it is determined that the second preset identifier (i.e., the second preset identifier in R1) carried by the first data recovery request initiated by the first terminal in the data W0-R4-W4-R1-W1-R4-W0 of another terminal S0 is packaged by an additional identifier R4. At this time, another terminal S0 needs to monitor whether the second terminal S3 sends the third data recovery request, and in a case that the second terminal S3 initiates the third data recovery request to each terminal within the signal coverage of the gateway in response to the data recovery command sent by the server, another terminal S0 sends the data R4-W4-R1-W1-R4 to the second terminal S3 in response to the third data recovery request of the second terminal S3. Then, for the second terminal S3 for which the data recovery is completed, the spliced data is W4-R1-W1-R1-W4; the second terminal S3 returns to execute step S52 until the data R1-W1-R1 are sent to the first terminal.

In some embodiments, the data transmission method further includes constructing terminal information. Specifically, the server receives terminal tasks and attribute information reported by the terminals and generates the terminal information of the terminals.

The terminal tasks and the attribute information reported by each terminal include, for example, a name of the terminal, an identity document (ID) of the terminal, a device attribute of the terminal, a remaining space and an occupancy rate of redundant space of an internal storage of the terminal, a storage path of the terminal information, read-write start pointer of an internal storage, a read-write function, and the like.

The server generates an internal storage table (i.e. the terminal information) according to the terminal tasks and the attribute information reported by each terminal, wherein the internal storage table includes information such as an IP, a remaining internal storage space, an occupancy rate of a redundant space, a standby port, a read-write function and the like corresponding to each terminal.

In the above embodiment, the case is included that the data scheduling request is actively initiated by the first terminal to transfer the data of the first terminal in different scenarios. Alternatively, in some embodiments, in order to improve the balance of the load capacity of each terminal in a distributed storage scenario, the server may periodically determine, according to the internal storage margin of each terminal, a third terminal that requires to transfer data; determine a second data scheduling plan according to a third data volume of the to-be-transferred data of the third terminal and the terminal information stored in the server, and send the second data scheduling plan to the third terminal. The second data scheduling plan includes information of each fourth terminal and a fourth data volume receivable by each fourth terminal; the fourth terminal is a terminal different from the third terminal within the gateway coverage.

Here, the manner of determining the second data scheduling plan may refer to the manner of generating the first data scheduling plan in the above embodiment. For example, referring to steps S221 and S222, specifically, according to the internal storage margin of each terminal in the terminal information, a terminal with the internal storage margin greater than or equal to the second preset threshold is selected from the terminals as a fourth terminal to receive the to-be-transferred data. The fourth data volume of the to-be-transferred data receivable by each fourth terminal is determined according to a ratio of the internal storage margins of the fourth terminals and the third data volume of the to-be-transferred data of the third terminal.

The third terminal receives the second data scheduling plan; and divides the to-be-transferred data having the third data volume into a plurality of pieces according to the fourth data volume receivable by each fourth terminal, and respectively sends the plurality of pieces to the fourth terminals.

The third terminal may send different pieces of sub-data to the fourth terminals according to IP information and a standby port of the fourth terminal indicated by the second data scheduling plan.

In this embodiment, the server periodically and actively initiates a load balancing request, monitors the internal storage space of each terminal, dynamically adjusts the internal storage margin of each terminal, and ensures that the internal storage margin of each terminal is balanced, thereby balancing the load burden of each terminal.

In some embodiments, since the terminal continuously generates the storage data, the occupancy rate of the mimicry internal storage space of the system component is greater than the maximum value for a certain time. For example, the mimicry internal storage space is full, and the user privacy data in the internal storage may be uploaded to the cloud. Specifically, the server detects the internal storage margin of each terminal, and initiates an internal storage cleaning request to each terminal within the signal coverage of the gateway in a case where the total redundant space of the internal storage margin is less than or equal to a third preset threshold; and the terminal uploads the to-be-cleaned data in the internal storage of the terminal to the server in response to the internal storage cleaning request. Here, the to-be-cleaned data is the user privacy data, and the user privacy data may be encrypted and then uploaded, which is not limited in the embodiment of the present disclosure. After the to-be-cleaned data is uploaded to the server, the mimicry internal storage space is released, so as to be used for the distributed storage of the to-be-transferred data of the terminal.

In a large-scale internet of things system, the risk of leakage and attack for the user privacy data is increased due to the increase of the connectivity of the user privacy data stored in the terminal. In the embodiments and the combination of the embodiments, the data transmission method provided by the embodiment of the present disclosure provides, based on the characteristics of the internet of things system, a scheme of adopting a local storage mechanism and realizing the safe storage without adding the safe hardware. Meanwhile, the terminal may adopt different data scheduling plans in different application scenarios. For example, the balanced transfer strategy that consumes a little bit more time but has a less consumption for the whole system may be selected; or the fast transfer strategy with short time consumption may be selected.

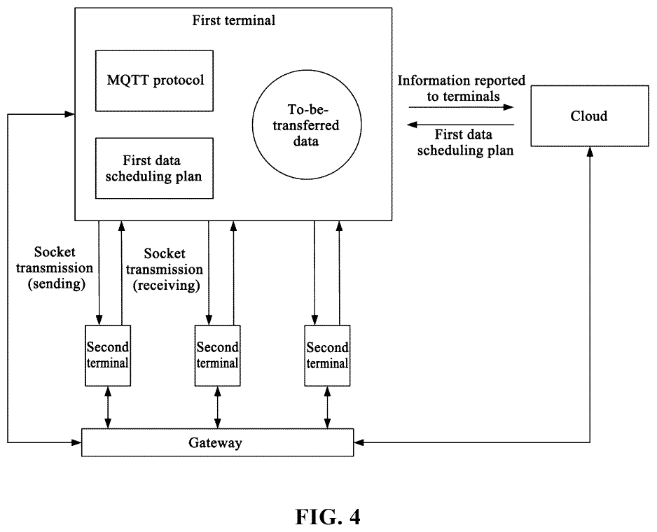

The embodiment of the present disclosure realizes the “distributed storage” among the terminals within the coverage of the local area network based on a protocol layer, and meets the distributed storage requirement of an underlying non-server device (i.e., the terminal). In some embodiments, a set of transmission protocols are involved in the local area network based on TCP/IP. FIG. 4 is a schematic diagram of a network transmission architecture according to an embodiment of the present disclosure. As shown in FIG. 4, the server is the cloud (that is, a cloud management platform) as an example, the first terminal establishes a connection with the cloud through the MQTT protocol; the first terminal divides the to-be-transferred data according to the received first data scheduling plan to obtain a plurality of pieces of sub-data; and then, the first terminal establishes a connection with the second terminal through the UDP protocol, and the first terminal respectively sends all the sub-data to the second terminals through a socket transmission mode. In addition, the first terminal sends the first data recovery request to the cloud through the MQTT protocol, and the cloud issues the first data recovery request to each terminal within the signal coverage of the gateway; and the second terminal returns the correspondingly stored data packet to the first terminal through the UDP protocol in response to the first data recovery request. The first terminal receives the sub-data in each data packet, and splices the sub-data together to obtain the recovery data.

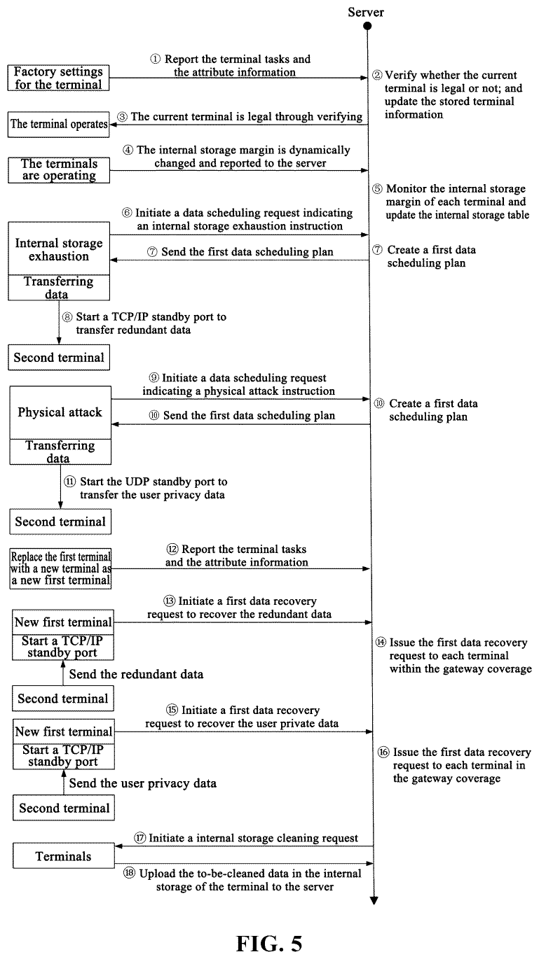

For convenience of understanding the data transmission method provided by the embodiment of the present disclosure, a detailed description for the data transmission method is given below with a complete example. FIG. 5 is a specific flowchart of a data transmission method according to an embodiment of the present disclosure. As shown in FIG. 5, \textcircled{1} factory settings for the terminal: the terminal tasks and the attribute information, such as a name, an ID, an IP, an SN, an internal storage space, a network speed, a port and the like are reported. \textcircled{2} The server verifies the current terminal, for example, verifies whether the current terminal is legal or not; and updates the stored terminal information (i.e., updating the original internal storage table, or adding the information of the current terminal). \textcircled{3} The current terminal is legal, and therefore, the current terminal may operate. \textcircled{4} The operation of the new device: the internal storage margin is dynamically changed and reported to the server. \textcircled{5} The server monitors the internal storage margin of each terminal and updates the internal storage table. In one case (including \textcircled{6}, \textcircled{7} and \textcircled{8}), \textcircled{6} if the internal storage of the first terminal is exhausted, a data scheduling request is initiated indicating an internal storage exhaustion instruction. \textcircled{7} The server creates a first data scheduling plan according to the internal storage table stored at the current moment and the first data volume of the to-be-transferred data in response to the internal storage exhaustion instruction indicated by the data scheduling request, and sends the first data scheduling plan to the first terminal. \textcircled{8} Transferring data of the first terminal: a TCP/IP standby port is started to transfer redundant data according to the first data scheduling plan. Alternatively, in another case (including \textcircled{9}, \textcircled{10} and \textcircled{11}), \textcircled{9} the first terminal initiates a data scheduling request indicating a physical attack instruction in case of physical attack. \textcircled{10} The server creates a first data scheduling plan according to the internal storage table stored at the current moment and the first data volume of the to-be-transferred data in response to the physical attack instruction indicated by the data scheduling request, and sends the first data scheduling plan to the first terminal. \textcircled{11} Transferring data of the first terminal: the UDP standby port is started to transfer the user privacy data according to the first data scheduling plan. \textcircled{12} A new terminal replaces the first terminal as a new first terminal, the new first terminal reports the terminal tasks and the attribute information, including a name, an ID, an IP, an SN, an internal storage space, a network speed, a port and the like, and the information of the new first terminal is the same as that of the replaced first terminal. In one case (including \textcircled{13} and \textcircled{14}), \textcircled{13} the new first terminal initiates a first data recovery request to recover redundant data while starting the TCP/IP standby port for receiving data fed back by the second terminal. \textcircled{14} The server issues the first data recovery request to each terminal within the coverage of the gateway. Alternatively, in another case (including \textcircled{15} and \textcircled{16}, \textcircled{15} the new first terminal initiates a first data recovery request to recover the user private data while starting the UDP standby port for receiving the data fed back by the second terminal. \textcircled{16} The server issues the first data recovery request to each terminal within the coverage of the gateway. \textcircled{17} The server initiates an internal storage cleaning request. \textcircled{18} The terminal uploads the to-be-cleaned data in the internal storage of the terminal to the server in response to the internal storage cleaning request.

FIG. 6 is a specific schematic flowchart of a data transmission method according to an embodiment of the present disclosure. As shown in FIG. 6, the server is the gateway as an example, a system includes a device side and a gateway side. The device side includes the first terminal and the second terminal, and the other terminals are not illustrated here.

The device side executes the following steps S61 to S67. The step S61 includes monitoring whether the data recovery request (including the first data recovery request and the second data recovery request) is broadcast in the local area network, if so, executing the step S62; if not, repeatedly executing S61. The step S62 includes determining whether the IP in the first preset identifier corresponding to the data scheduling plan (the first data scheduling plan and the second data scheduling plan) is the IP of the current device; if not, executing the step S63; and if so, executing the step S66. The step S63 includes determining whether the second preset identifier carried by the received data recovery request exists in the internal storage; if so, executing the step S64; if not, returning to execute the step S61. The Step S64 includes determining whether the second preset identifier is packaged by additional identifiers; if so, returning to the step S61; if not, executing the step S65. The step S65 includes starting a standby port corresponding to the protocol to prepare for sending the data according to the data scheduling plan. The Step S66 includes starting a standby port corresponding to the protocol to prepare for receiving the data according to the data scheduling plan. The step S67 includes, after the reception is completed, broadcasting a data recovery completion signal, and executing step S74.

The gateway side executes the following steps S71 to S77. The step S71 includes monitoring whether the data recovery request (including the first data recovery request and the second data recovery request) is broadcast in the local area network; if so, executing the step S72; if not, executing the step S74. The step S72 includes determining whether the data scheduling plan (each data scheduling plan is provided with a corresponding first preset identifier including the second preset identifier) matched with the second preset identifier carried by the currently broadcasted data recovery request is a plan arranged at the top of a plan queue; if so, returning to execute the step S71; if not, executing the step S73. The step S73 includes broadcasting the data scheduling plan arranged at the top of the plan queue, and broadcasting to interrupt the on-going splicing. The step S74 includes monitoring whether a data recovery completion signal is broadcast in the local area network; if so, executing the step S75; if not, returning to execute the step S71. The step S75 includes deleting the plan at the top of the plan queue.

Another data transmission method provided in the embodiments of the present disclosure is described in detail below, and an executing entity of the data transmission method may be the first terminal. Specifically, the method includes: determining a first data scheduling plan according to a first data volume of to-be-transferred data of the first terminal and terminal information received from a server, in response to a data scheduling request, wherein the terminal information includes information of each terminal within the signal coverage of the gateway, the first data scheduling plan includes information of each second terminal and a second data volume receivable by each second terminal, the second terminal is a terminal different from the first terminal within the coverage of the gateway, and the first terminal is a terminal which sends the data scheduling request within the coverage of the gateway; dividing the to-be-transferred data with the first data volume into a plurality of pieces according to the second data volume receivable by each second terminal to obtain each piece of sub-data; and sending each piece of the sub-data to the corresponding second terminal respectively.

In the data transmission method provided in the embodiment of the present disclosure, the first terminal is configured to generate the first data scheduling plan, the principle of which is the same as that of generating the first data scheduling plan by using the server in the data transmission method in the foregoing embodiments, and repeated descriptions are omitted.

The manners of communication between the first terminal and the second terminal and the transmitting the to-be-transferred data may refer to the detailed process of the data transmission method provided in the foregoing embodiments, and repeated details are not described herein.

A local storage mechanism is adopted in the embodiment of the present disclosure. The “local” herein refers to a mimicry internal storage space formed by terminals within a signal coverage of the same gateway. The to-be-transferred data in a first terminal is stored in a local internal storage space of a second terminal within the signal coverage of the same gateway, so that the distributed storage of the to-be-transferred data is achieved. A speed of the data transmission among the terminals is higher than that between each terminal and the cloud, and therefore fast backup of the data may be achieved through the local storage. In addition, compared with the traditional technology, in the embodiments of the present disclosure, the encryption storage device is unnecessarily provided, the backup data is unnecessarily frequently uploaded at the terminal, and the risk is reduced that the network transmission data is stolen.

In some embodiments, the determining a first data scheduling plan according to a first data volume of to-be-transferred data of the first terminal and terminal information received from a server, includes:

acquiring the terminal information from the server in response to the data scheduling request initiated by the first terminal and indicating the internal storage exhaustion instruction in a case where it is detected that an internal storage margin of the first terminal is less than or equal to a first preset threshold, and determining the first data scheduling plan according to the internal storage margin of each terminal in the terminal information and the first data volume of the to-be-transferred data.

In some embodiments, the determining the first data scheduling plan according to the internal storage margin of each terminal in the terminal information and the first data volume of the to-be-transferred data, includes:
selecting a terminal with the internal storage margin greater than or equal to a second preset threshold from the terminals as a second terminal to receive to-be-transferred data according to the internal storage margin of each terminal in the terminal information; and
determining the second data volume of the to-be-transferred data receivable by each second terminal, according to a ratio of the internal storage margins of the second terminals and the first data volume of the to-be-transferred data.

In some embodiments, the first terminal and the second terminal are communicated with each other through the transmission control protocol TCP or the internet protocol IP.

In some embodiments, the determining a first data scheduling plan according to a first data volume of to-be-transferred data of the first terminal and terminal information received from a server, includes:
acquiring the terminal information from the server in response to the data scheduling request initiated by the first terminal and indicating that the first terminal is physically attacked in a case where it is detected that the first terminal is physically attacked, and determining the first data scheduling plan according to the internal storage margin of each terminal in the terminal information and the first data volume of the to-be-transferred data.

In some embodiments, the determining the first data scheduling plan according to the internal storage margin of each terminal in the terminal information and the first data volume of the to-be-transferred data, includes:
selecting a terminal with the internal storage margin greater than or equal to the second preset threshold from the terminals as the second terminal to receive the to-be-transferred data, according to the internal storage margin of each terminal in the terminal information;
determining a data transmission time length of each second terminal according to the data transmission speed of each second terminal and the first data volume of the to-be-transferred data; wherein the data transmission time lengths of the second terminals are the same;
determining whether the data volume to be received by the second terminal exceeds the internal storage margin of the second terminal according to the data transmission speed and the data transmission time length of each second terminal; and
determining the data volume to be received by each second terminal as the second data volume of to-be-transferred data to be received in a case where the data volume to be received by any second terminal does not exceed the internal storage margin of the second terminal.

In some embodiments, the data transmission method further includes:
determining, in a case where the data volume to be received by a second terminal exceeds the internal storage margin of the second terminal, the second terminal as a target second terminal, and determining the second data volume receivable by the target second terminal as the internal storage margin of the target second terminal; and
for remaining second terminals other than the target second terminal, returning to execute the determining a data transmission time length of each second terminal according to the data transmission speed of each second terminal and the first data volume of the to-be-transferred data, until the data volume to be received by each of remaining second terminals does not exceed the internal storage margin of the remaining second terminal, to determine the second data volumes of the to-be-transferred data receivable by the remaining second terminals.

In some embodiments, the first terminal and the second terminal are communicated to each other via the user datagram protocol UDP.

In some embodiments, the sending the respective pieces of sub-data to the second terminals includes: for each piece of sub-data, adding a group of first preset identifiers before the sub-data, and adding a group of first preset identifiers after the sub-data to obtain a data packet containing the first preset identifiers and the sub-data, wherein the first preset identifiers added to different sub-data indicate different splicing sequence numbers; and respectively sending the data packets corresponding to the pieces of sub-data to the corresponding second terminals.

In addition, the embodiment of the present disclosure further provides another data transmission method, and an executing entity of the data transmission method may be a data transmission device with a computing capability, and integrated with a server and at least one terminal in a signal coverage of the gateway. The server may be a gateway, a cloud, or an advanced terminal. The advanced terminal so-called refers to a terminal with a high computing capability.

In the data transmission method, the first data scheduling plan is generated by the first terminal, which may specifically refer to the data transmission method by using the first terminal as an executing entity, and repeated descriptions are omitted.

The data transmission method further includes a data recovery process.

In some embodiments, the first terminal sends a first data recovery request to each terminal within the signal coverage of the gateway, so that each terminal determines whether it is a terminal storing the data packet of the first terminal in response to the first data recovery request.

The second terminal may determine a data packet matched with the second preset identifier carried by the first data recovery request according to the first preset identifier in the data packet, in response to the first data recovery request, and send the data packet to the first terminal.

The first terminal receives the data packets sent by the second terminals, and splices the sub-data in the data packets according to the splicing sequence numbers indicated by the first preset identifiers in the data packets to obtain the recovery data.

It should be noted that for a specific implementation of the present embodiment, reference may be made to implementation of the foregoing steps S41 to S43, and repeated descriptions are omitted.

In some embodiments, the first terminal sends a first data recovery request to each terminal and the server within the gateway coverage, so that each terminal determines whether this terminal is the terminal that stores the data packet of the first terminal in response to the first data recovery request.

The second terminal determines whether the second preset identifier carried by the first data recovery request exists in the data stored in the second terminal, in response to the first data recovery request.

A second data recovery request for requesting to recover the self-transferred data (the data transferred by the second terminal) is initiated, in response to a command sent by the server for recovering the data of the second terminal by the server if the data stored in the second terminal does not have the second preset identifier carried by the first data recovery request.

The determining whether the second preset identifier carried by the first data recovery request exists in the data stored by the second terminal is repeatedly executed in response to the first data recovery request when the data recovery of the second terminal is completed.

In some embodiments, with reference to the foregoing embodiments, it is determined whether the second preset identifier is packaged by additional identifiers if the second preset identifier carried by the first data recovery request exists in the data stored by the second terminal.

A data packet corresponding to the second preset identifier is sent to the first terminal if the second preset identifier is not packaged by additional identifiers.

In some embodiments, with reference to the foregoing embodiments, if the second preset identifier is packaged by additional identifiers, the second terminal monitors whether the terminal corresponding to the additional identifier sends a third data recovery request, so as to send the data packet corresponding to the additional identifier to the terminal corresponding to the additional identifier in response to the third data recovery request.

It should be noted that for the specific execution process of the request for recovering data in combination with the foregoing embodiments, reference may be made to the execution processes of the steps S51 to S57, and repeated details are not repeated.

In some embodiments, the data transmission method further includes: receiving, by the server, terminal tasks and attribute information reported by the terminals to generate the terminal information of the terminals.

In some embodiments, the server may periodically determine, according to the internal storage margin of each terminal, a third terminal to transfer data; determine a second data scheduling plan of the third terminal according to a third data volume of the to-be-transferred data of the third terminal and the terminal information stored in the server, and send the second data scheduling plan to the third terminal. The second data scheduling plan includes information of each fourth terminal and a fourth data volume receivable by each fourth terminal, and the fourth terminal is a terminal different from the third terminal within the gateway coverage. The third terminal receives the second data scheduling plan; and divides the to-be-transferred data with the third data volume into a plurality of pieces according to the fourth data volume receivable by each fourth terminal, and respectively sends the plurality of pieces to the fourth terminals.

In some embodiments, the server detects the internal storage margin of each terminal, and initiates an internal storage cleaning request to each terminal within the signal coverage of the gateway in a case where the total redundant space of the internal storage margin is less than or equal to a third preset threshold; and the terminal uploads the to-be-cleaned data in the internal storage of the terminal to the server in response to the internal storage cleaning request.

It will be understood by one of ordinary skill in the art that in the above method for the present embodiment, the written order of the steps does not imply a strict order of executing the steps and does not impose any limitations on the implementation, as the specific order of executing the steps should be determined by their functions and possibly inherent logic.

In addition, the embodiment of the present disclosure further provides a data transmission device corresponding to the data transmission method, and since the principle of solving the problem by the device in the embodiment of the present disclosure is similar to that of the data transmission method in the embodiment of the present disclosure, the implementation of the device may refer to the implementation of the method, and repeated parts are not described again.

The embodiment of the present disclosure provides a data transmission device, which is applied to the data transmission method with an executing entity integrated with a server and at least one terminal in a signal coverage of the gateway. The server may be a gateway, a cloud, or an advanced terminal. The advanced terminal so-called refers to a terminal with a high computing capability.

The server is configured to determine, in response to a data scheduling request sent by a first terminal, a first data scheduling plan of a first terminal according to a first data volume of the to-be-transferred data of the first terminal carried in the data scheduling request and terminal information stored in the server, and send the first data scheduling plan to the first terminal. The terminal information includes information of each terminal within a signal coverage of a gateway. The first data scheduling plan includes information of each second terminal and a second data volume receivable by each second terminal; the first terminal is a terminal to transfer the to-be-transferred data therein within the signal coverage of the gateway, and the second terminal is a terminal different from the first terminal within the signal coverage of the gateway.

The first terminal is configured to receive the first data scheduling plan, and divide the to-be-transferred data with the first data volume into a plurality of pieces of sub-data according to the second data volume receivable by each second terminal, to obtain each piece of sub-data; and send each piece of sub-data to the second terminals.

In some embodiments, the first terminal is configured to initiate the data scheduling request to the server in a case where it is detected by the first terminal that an internal storage margin of the first terminal is less than or equal to a first preset threshold.

The server is configured to, in response to an internal storage exhaustion instruction indicated by the data scheduling request, determine the first data scheduling plan according to the internal storage margin of each terminal in the terminal information and the first data volume of the to-be-transferred data carried in the data scheduling request.

In some embodiments, the server is configured to select a terminal with the internal storage margin greater than or equal to a second preset threshold from the terminals, as the second terminal to receive the to-be-transferred data, according to the internal storage margin of each terminal in the terminal information; determine the second data volume of the to-be-transferred data receivable by each second terminal, according to a ratio of the internal storage margins of the second terminals and the first data volume of the to-be-transferred data.

In some embodiments, the first terminal and the second terminal are communicated with each other through the transmission control protocol TCP or the internet protocol IP.

In some embodiments, the first terminal is configured to initiate the data scheduling request to the server in a case where it is detected by the first terminal that the first terminal is physically attacked.

The server is configured to determine, in response to a physical attack instruction indicated by the data scheduling request, the first data scheduling plan according to the internal storage margin of each terminal in the terminal information and the first data volume of the to-be-transferred data carried in the data scheduling request.

In some embodiments, the server is specifically configured to select a terminal with the internal storage margin greater than or equal to a second preset threshold from the terminals according to the internal storage margin of each terminal in the terminal information, as the second terminal to receive the to-be-transferred data; determine a data transmission time length of each second terminal according to a data transmission speed of each second terminal and the first data volume of the to-be-transferred data, wherein the data transmission time lengths of the second terminals are the same; determine whether a data volume to be received by the second terminal exceeds the internal storage margin of the second terminal according to the data transmission speed and the data transmission time length of each second terminal; and determine the data volume to be received by the second terminal as the second data volume of the to-be-transferred data to be received in response that the data volume to be received by any second terminal does not exceed the internal storage margin of the second terminal.

In some embodiments, the server is specifically further configured to determine, in a case where the data volume to be received by a second terminal exceeds the internal storage margin of the second terminal, the second terminal as a target second terminal, and determining the second data volume receivable by the target second terminal as the internal storage margin of the target second terminal; and for remaining second terminals other than the target second terminal, return to execute the determining the data transmission time length of each second terminal according to the data transmission speed of each second terminal and the first data volume of the to-be-transferred data, until the data volume to be received by each of the remaining second terminals does not exceed the internal storage margin of each of the remaining second terminals, and determine the second data volumes of the to-be-transferred data receivable by the remaining second terminals.

In some embodiments, the first terminal and the second terminal are communicated to each other via the user datagram protocol UDP.

In some embodiments, the first terminal is specifically configured to, for each piece of sub-data, add a group of first preset identifiers before the sub-data, and add a group of first preset identifiers after the sub-data to obtain a data packet containing the preset identifiers and the sub-data, wherein the first preset identifiers added to different sub-data indicate different splicing sequence numbers; and respectively send the data packets corresponding to the pieces of sub-data to the corresponding second terminals for reception.

In some embodiments, the first terminal is further configured to send a first data recovery request to each terminal within the signal coverage of the gateway, so that each terminal determines whether the terminal is a terminal having stored the data packet of the first terminal in response to the first data recovery request.

The second terminal is configured to determine, in response to the first data recovery request, a data packet matched with the second preset identifier carried by the first data recovery request according to the first preset identifier in the data packet, and send the data packet to the first terminal.

The first terminal is configured to receive the data packets sent by the second terminals, and splice the sub-data in the data packets according to the splicing sequence numbers indicated by the first preset identifiers in the data packets, to obtain the recovery data.

In some embodiments, the first terminal is configured to send a first data recovery request to each terminal and the server within the gateway coverage, so that each terminal determines whether the terminal is the terminal having stored the data packet of the first terminal in response to the first data recovery request.

The second terminal is configured to determine whether the second preset identifier carried by the first data recovery request exists in the data stored in the second terminal in response to the first data recovery request; initiate a second data recovery request for requesting to recover the self-transferred data (the data transferred by the second terminal) in response to a command sent by the server for recovering the data of the second terminal if the data stored in the second terminal does not have the second preset identifier carried by the first data recovery request; and repeatedly execute the determining whether the second preset identifier carried by the first data recovery request exists in the data stored in the second terminal in response to the first data recovery request when the data recovery of the second terminal is completed.

In some embodiments, the second terminal is configured to determine whether the second preset identifier is packaged by additional identifiers if the second preset identifier carried by the first data recovery request exists in the data stored in the second terminal; and send a data packet corresponding to the second preset identifier to the first terminal if the second preset identifier is not packaged by additional identifiers.

In some embodiments, the second terminal is further configured to monitor whether the terminals corresponding to additional identifiers send a third data recovery request, if the second preset identifier is packaged by additional identifiers, so as to send the data packets corresponding to additional identifiers to the terminals corresponding to additional identifiers in response to the third data recovery request.

In some embodiments, the server is further configured to receive terminal tasks and attribute information reported by the terminals to generate the terminal information of the terminals.

In some embodiments, the server is further configured to periodically determine, according to the internal storage margin of each terminal, a third terminal that requires to transfer data; determine a second data scheduling plan of the third terminal according to a third data volume of the to-be-transferred data of the third terminal and the terminal information stored in the server, and send the second data scheduling plan to the third terminal. The second data scheduling plan includes information of each fourth terminal and a fourth data volume receivable by each fourth terminal; and the fourth terminal is a terminal different from the third terminal within the gateway coverage.

The third terminal is configured to receive the second data scheduling plan; and divide the to-be-transferred data with the third data volume into a plurality of pieces according to the fourth data volume receivable by each fourth terminal, and respectively send the plurality of pieces to the fourth terminals.

In some embodiments, the server is further configured to detect the internal storage margin of each terminal, and initiate an internal storage cleaning request to each terminal within the signal coverage of the gateway in a case where the total redundant space of the internal storage margin is less than or equal to a third preset threshold; and the terminal is configured to upload the to-be-cleaned data in the internal storage of the terminal to the server in response to the internal storage cleaning request.

The embodiment of the present disclosure provides another data transmission device applied to the data transmission method in which the executing entity is the first terminal. The data transmission device includes a first terminal, and the first terminal includes a first processing component, a second processing component and a sending module.

The first processing component is configured to determine, in response to a data scheduling request, a first data scheduling plan according to a first data volume of a to-be-transferred data of a first terminal and terminal information received from a server, wherein the terminal information comprises information of each terminal within a signal coverage of the gateway, the first data scheduling plan comprises information of each second terminal and a second data volume receivable by each second terminal, the second terminal is a terminal different from the first terminal within the signal coverage of the gateway, and the first terminal is a terminal which sends the data scheduling request within the signal coverage of the gateway.

The second processing component is configured to divide the to-be-transferred data with the first data volume into a plurality of pieces according to the second data volume receivable by each second terminal to obtain each piece of sub-data.

The sending module is configured to send each piece of the sub-data to the corresponding second terminal respectively.

In some embodiments, the first processing component is specifically configured to acquire the terminal information from the server, and determine the first data scheduling plan according to the internal storage margin of each terminal in the terminal information and the first data volume of the to-be-transferred data in response to the data scheduling request initiated by the first terminal and indicating the internal storage exhaustion instruction in a case where it is detected that an internal storage margin of the first terminal is less than or equal to a first preset threshold.

In some embodiments, the first processing component is specifically configured to screen out terminals with the internal storage margin greater than or equal to a second preset threshold as second terminals to receive to-be-transferred data from the terminals according to the internal storage margin of each terminal in the terminal information; and determine the second data volume of the to-be-transferred data receivable by each second terminal, according to a ratio of the internal storage margins of the second terminals and the first data volume of the to-be-transferred data.

In some embodiments, the first terminal and the second terminal are communicated with each other through the transmission control protocol TCP or the internet protocol IP.

In some embodiments, the first processing component is specifically configured to, in response to the data scheduling request initiated by the first terminal and indicating that the first terminal is physically attacked, acquire the terminal information from the server in a case where it is detected that the first terminal is physically attacked, and determine the first data scheduling plan according to the internal storage margin of each terminal in the terminal information and the first data volume of the to-be-transferred data.

In some embodiments, the first processing component is specifically configured to select a terminal with the internal storage margin greater than or equal to a second preset threshold from the terminals according to the internal storage margin of each terminal in the terminal information, as the second terminal to receive the to-be-transferred data; determine a data transmission time length of each second terminal according to a data transmission speed of each second terminal and the first data volume of the to-be-transferred data, wherein the data transmission time lengths of the second terminals are the same; determine whether a data volume to be received by the second terminal exceeds the internal storage margin of the second terminal according to the data transmission speed and the data transmission time length of each second terminal; and determine the data volume to be received by the second terminal as the second data volume of the to-be-transferred data to be received in response that the data volume to be received by any second terminal does not exceed the internal storage margin of the second terminal.

In some embodiments, the first processing component is further configured to determine, in a case where the data volume to be received by a second terminal exceeds the internal storage margin of the second terminal, the second terminal as a target second terminal, and determine the second data volume receivable by the target second terminal as the internal storage margin of the target second terminal; and for remaining second terminals other than the target second terminal, return to execute the determining the data transmission time length of each second terminal according to the data transmission speed of each second terminal and the first data volume of the to-be-transferred data, until the data volume to be received by each of the remaining second terminals does not exceed the internal storage margin of each of the remaining second terminals, and determine the second data volumes of the to-be-transferred data receivable by the remaining second terminals.

In some embodiments, the first terminal and the second terminal are communicated to each other via the user datagram protocol UDP.

In some embodiments, the sending module is specifically configured to for each piece of sub-data, add a group of first preset identifiers before the sub-data, and add a group of first preset identifiers after the sub-data to obtain a data packet containing the preset identifiers and the sub-data, wherein the first preset identifiers added to different sub-data indicate different splicing sequence numbers; and respectively send the data packets corresponding to the pieces of sub-data to the corresponding second terminals.

Further, the data transmission device provided by the embodiment of the present disclosure further includes a second terminal and a server. The data transmission device is further configured to realize the data recovery of the first terminal.

In some embodiments, the first terminal is configured to send a first data recovery request to each terminal within the signal coverage of the gateway, so that each terminal determines whether the terminal is a terminal having stored the data packet of the first terminal in response to the first data recovery request.

The second terminal is configured to determine a data packet matched with the second preset identifier carried by the first data recovery request according to the first preset identifier in the data packet, in response to the first data recovery request, and send the data packet to the first terminal.

The first terminal is configured to receive the data packets sent by the second terminals, and splice the sub-data in the data packets according to the splicing sequence numbers indicated by the first preset identifiers in the data packets to obtain the recovery data.

In some embodiments, the first terminal is configured to send a first data recovery request to each terminal and the server in the gateway coverage, so that each terminal determines whether the terminal is the terminal having stored the data packet of the first terminal in response to the first data recovery request.

The second terminal is configured to determine whether the second preset identifier carried by the first data recovery request exists in the data stored in the second terminal, in response to the first data recovery request; initiate a second data recovery request for requesting to recover the self-transferred data (the data transferred by the second terminal) in response to a command sent by the server for recovering the data of the second terminal, if the second preset identifier carried by the first data recovery request does not exist in the data stored in the second terminal; and repeatedly execute the determining whether the second preset identifier carried by the first data recovery request exists in the data stored in the second terminal in response to the first data recovery request when the data recovery of the second terminal is completed.

In some embodiments, the second terminal is further configured to determine whether the second preset identifier is packaged by additional identifiers if the second preset identifier carried by the first data recovery request exists in the data stored in the second terminal; and send a data packet corresponding to the second preset identifier to the first terminal if the second preset identifier is not packaged by additional identifiers.

In some embodiments, the second terminal is further configured to monitor whether the terminals corresponding to additional identifiers send a third data recovery request, if the second preset identifier is packaged by additional identifiers, so as to send the data packets corresponding to additional identifiers to the terminals corresponding to additional identifiers in response to the third data recovery request.

In some embodiments, the server is further configured to receive terminal tasks and attribute information reported by the terminals to generate the terminal information of the terminals.

In some embodiments, the server is further configured to periodically determine, according to the internal storage margin of each terminal, a third terminal that requires to transfer data; determine a second data scheduling plan of the third terminal according to a third data volume of the to-be-transferred data of the third terminal and the terminal information stored in the server, and send the second data scheduling plan to the third terminal. The second data scheduling plan includes information of each fourth terminal and a fourth data volume receivable by each fourth terminal; and the fourth terminal is a terminal different from the third terminal within the gateway coverage. The third terminal is configured to receive the second data scheduling plan; and divide the to-be-transferred data with the third data volume into a plurality of pieces according to the fourth data volume receivable by each fourth terminal, and respectively send the plurality of pieces to the fourth terminals.

In some embodiments, the server is further configured to detect the internal storage margin of each terminal, and initiate an internal storage cleaning request to each terminal within the signal coverage of the gateway in a case where the total redundant space of the internal storage margin is less than or equal to a third preset threshold; and the terminal is configured to upload the to-be-cleaned data in the internal storage of the terminal to the server in response to the internal storage cleaning request.

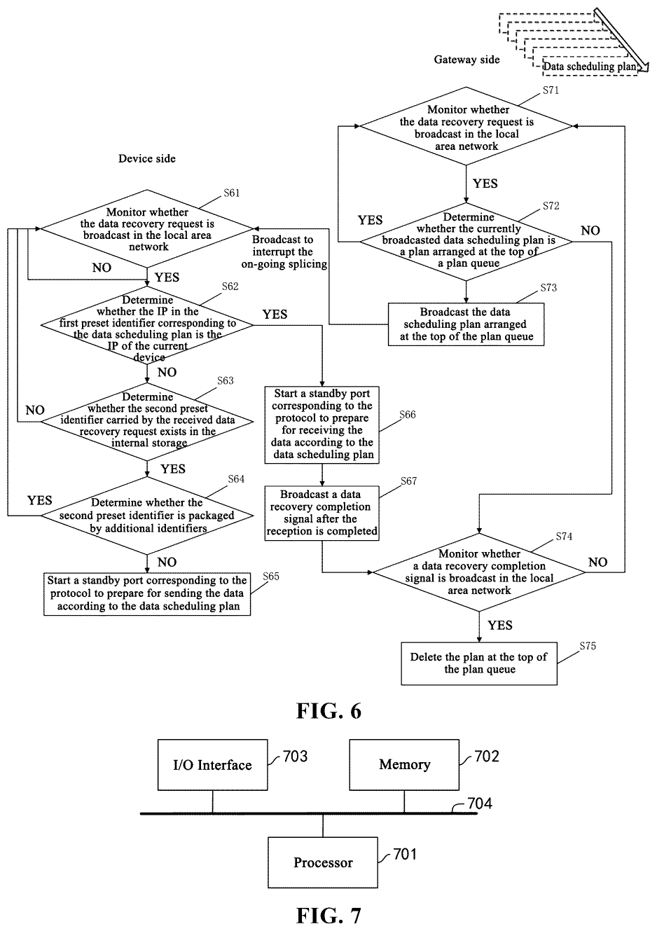

FIG. 7 is a schematic diagram of a structure of a computer device according to an embodiment of the present disclosure. As shown in FIG. 7, an embodiment of the present disclosure provides a computer device, including: one or more processors 701, a memory 702, and one or more I/O interfaces 703. The memory 702 stores one or more programs thereon that when executed by the one or more processors, cause the one or more processors to implement the data transmission method in any one of the above embodiments. The one or more I/O interfaces 703 are connected between the processors and the memory and are configured to enable information interaction between the processors and the memory.

Each processor 701 is a device with the data processing capability, and includes, but is not limited to, a central processing unit (CPU) or the like; the memory 702 is a device with the data storage capability, and includes, but is not limited to, a random access memory (RAM, more specifically SDRAM, DDR, etc.), a read only memory (ROM), an electrically erasable programmable read only memory (EEPROM), a flash. Each I/O interface (read/write interface) 703 is connected between the processors 701 and the memory 602, may enable information interaction between the processors 701 and the memory 702, and includes, but is not limited to, a data bus or the like.

In some embodiments, the processors 701, the memory 702, and the I/O interfaces 703 are connected to each other by the bus 704, and to other components of the computer device.

The embodiment of the present disclosure further provides a non-transitory computer readable storage medium. The non-transitory computer readable storage medium has a computer program stored thereon, and the computer program, when being executed by a processor, causes the processor to perform steps of the data transmission method in any one of the embodiments.

In particular, according to the embodiments of the present disclosure, the processes described above with reference to the flowcharts may be implemented as computer software programs. For example, the embodiments of the present disclosure provide a computer program product, including a computer program embodied on a machine-readable medium, the computer program includes program codes for performing the method illustrated in the flowcharts. In such an embodiment, the computer program may be downloaded from a network via a communication portion and installed, and/or installed from a detachable medium. The computer program, when executed by a central processing unit (CPU), causes the central processing unit to perform the above functions defined in the system of the present disclosure.

It should be noted that the non-transitory computer readable medium shown in the present disclosure may be a computer readable signal medium or a computer readable storage medium or any combination thereof. The computer readable storage medium may be, for example, but not limited to, an electronic, magnetic, optical, electromagnetic, infrared, or semiconductor system, apparatus, or device, or any combination thereof. More specific examples of the computer readable storage medium may include, but are not limited to: an electrical connection having one or more wires, a portable computer disk, a hard disk, a random access memory (RAM), a read-only memory (ROM), an erasable programmable read-only memory (EPROM) or a flash, an optical fiber, a portable compact disc read-only memory (CD-ROM), an optical storage device, a magnetic storage device, or any suitable combination therefore. In the present disclosure, the computer readable storage medium may be any tangible medium that can contain or store a program for use by or in connection with an instruction execution system, apparatus, or device. In contrast, in the present disclosure, the computer readable signal medium may include a data signal with computer readable program code embodied therein, for example, propagated in baseband or as part of a carrier wave. Such the propagated data signal may take any of a variety of forms, including, but not limited to, an electromagnetic signal, an optical signal, or any suitable combination thereof. The computer readable signal medium may be any non-transitory computer readable storage medium in addition to the computer readable storage medium, and the non-transitory computer readable storage medium may transmit, propagate, or transport a program for use by or in connection with an instruction execution system, apparatus, or device. The program code embodied on the non-transitory computer readable storage medium may be transmitted in any appropriate way, including, but not limited to: wirelessly, through wires, fiber optic cables, RF (radio frequency) or the like, or any suitable combination thereof.

The flowchart and block diagrams in the drawings illustrate architecture, functionality, and operation of possible implementations of a device, a method and a computer program product according to various embodiments of the present disclosure. In this regard, each block in the flowchart or block diagrams may represent a module, program segment(s), or a portion of a code, which includes one or more executable instructions for implementing specified logical function(s). It should also be noted that, in some alternative implementations, functions noted in the blocks may occur out of the order noted in the drawings. For example, two blocks connected to each other may, in fact, be performed substantially concurrently, or the blocks may sometimes be performed in the reverse order, depending upon the functionality involved. It will also be noted that each block of the block diagrams and/or flowchart, and combinations of blocks in the block diagrams and/or flowchart, may be implemented by special purpose hardware-based systems that perform the specified functions or operations, or combinations of special purpose hardware and computer instructions.

It should be understood that the above embodiments are merely exemplary embodiments adopted to explain the principles of the present disclosure, and the present disclosure is not limited thereto. It will be apparent to one of ordinary skill in the art that various changes and modifications may be made therein without departing from the spirit and scope of the present disclosure, and such changes and modifications also fall within the scope of the present disclosure.

1. A data transmission method, comprising:
by a server, determining, in response to a data scheduling request sent by a first terminal, a first data scheduling plan of the first terminal according to a first data volume of a to-be-transferred data of the first terminal carried in the data scheduling request and terminal information stored in the server, and sending the first data scheduling plan to the first terminal, wherein the terminal information comprises information of each of terminals within a signal coverage of a gateway, the first data scheduling plan comprises information of each of second terminals and a second data volume receivable by each second terminal, the first terminal is a terminal among the terminals to transfer the to-be-transferred data therein within the signal coverage of the gateway, and the second terminal is a terminal among the terminals different from the first terminal within the signal coverage of the gateway; and
by the first terminal, receiving the first data scheduling plan, dividing the to-be-transferred data with the first data volume into a plurality of pieces of sub-data according to the second data volume receivable by each second terminal to obtain each piece of sub-data, and sending each piece of sub-data to the second terminal.

2. The data transmission method according to claim 1, wherein the determining, by the server in response to the data scheduling request sent by the first terminal, the first data scheduling plan of the first terminal according to the first data volume of the to-be-transferred data of the first terminal carried in the data scheduling request and terminal information stored in the server, comprises:
initiating, by the first terminal, the data scheduling request to the server in response that it is detected by the first terminal that an internal storage margin of the first terminal is less than or equal to a first preset threshold; and
determining, by the server in response to an internal storage exhaustion instruction indicated by the data scheduling request, the first data scheduling plan according to an internal storage margin of each terminal in the terminal information and the first data volume of the to-be-transferred data carried in the data scheduling request.

3. The data transmission method according to claim 2, wherein the determining the first data scheduling plan according to the internal storage margin of each terminal in the terminal information and the first data volume of the to-be-transferred data carried in the data scheduling request, comprises:
selecting a terminal with the internal storage margin greater than or equal to a second preset threshold from the terminals according to the internal storage margin of each terminal in the terminal information, as the second terminal to receive the to-be-transferred data; and
determining the second data volume of the to-be-transferred data receivable by each second terminal, according to a ratio of the internal storage margins of the second terminals and the first data volume of the to-be-transferred data.

4. The data transmission method according to claim 1, wherein the first terminal and the second terminal are communicated with each other via a transmission control protocol TCP or an internet protocol IP.

5. The data transmission method according to claim 1, wherein the determining, by a server in response to the data scheduling request sent by the first terminal, the first data scheduling plan of the first terminal according to the first data volume of the to-be-transferred data of the first terminal carried in the data scheduling request and terminal information stored in the server, comprises:
initiating, by the first terminal, the data scheduling request to the server in response that it is detected by the first terminal that the first terminal is physically attacked; and
determining, by the server in response to a physical attack instruction indicated by the data scheduling request, the first data scheduling plan according to the internal storage margin of each terminal in the terminal information and the first data volume of the to-be-transferred data carried in the data scheduling request.

6. The data transmission method according to claim 5, wherein the determining the first data scheduling plan according to the internal storage margin of each terminal in the terminal information and the first data volume of the to-be-transferred data carried in the data scheduling request, comprises:
selecting a terminal with the internal storage margin greater than or equal to a second preset threshold from the terminals according to the internal storage margin of each terminal in the terminal information, as the second terminal to receive the to-be-transferred data;
determining a data transmission time length of each second terminal according to a data transmission speed of each second terminal and the first data volume of the to-be-transferred data, wherein the data transmission time lengths of the second terminals are the same;
determining whether a data volume to be received by the second terminal exceeds the internal storage margin of the second terminal according to the data transmission speed and the data transmission time length of each second terminal; and
determining the data volume to be received by the second terminal as the second data volume of the to-be-transferred data to be received in response that the data volume to be received by any second terminal does not exceed the internal storage margin of the second terminal.

7. The data transmission method according to claim 6, wherein the data transmission method further comprises:
determining, in a case where the data volume to be received by the second terminal exceeds the internal storage margin of the second terminal, the second terminal as a target second terminal, and determining the second data volume receivable by the target second terminal as the internal storage margin of the target second terminal; and
for remaining second terminals other than the target second terminal, returning to execute the determining the data transmission time length of each second terminal according to the data transmission speed of each second terminal and the first data volume of the to-be-transferred data, until the data volume to be received by each of the remaining second terminals does not exceed the internal storage margin of each of the remaining second terminals, and determining the second data volumes of the to-be-transferred data receivable by the remaining second terminals.

8. The data transmission method according to claim 5, wherein the first terminal and the second terminal are communicated to each other via a user datagram protocol UDP.

9. The data transmission method according to claim 1, wherein the sending the respective pieces of sub-data to the second terminals, comprises:
for each piece of sub-data, adding a group of first preset identifiers before the sub-data, and adding a group of first preset identifiers after the sub-data to obtain a data packet containing the preset identifiers and the sub-data, wherein the first preset identifiers added to different sub-data indicate different splicing sequence numbers; and
respectively sending the data packets corresponding to the pieces of sub-data to the corresponding second terminals for reception.

10. The data transmission method according to claim 9, wherein the data transmission method further comprises:
sending, by the first terminal, a first data recovery request to each terminal within the signal coverage of the gateway, so that each terminal determines whether the terminal is a terminal having stored the data packet of the first terminal in response to the first data recovery request;
determining, by the second terminal in response to the first data recovery request, a data packet matched with the second preset identifier carried by the first data recovery request according to the first preset identifier in the data packet, and sending the data packet to the first terminal; and
receiving, by the first terminal, the data packets sent by the second terminals, and splicing the sub-data in the data packets according to the splicing sequence numbers indicated by the first preset identifiers in the data packets to obtain recovery data.

11. The data transmission method according to claim 9, wherein the data transmission method further comprises:
sending, by the first terminal, a first data recovery request to each terminal and the server within the signal coverage of the gateway, so that each terminal determines whether the terminal is the terminal having stored the data packet of the first terminal in response to the first data recovery request;
determining, by the second terminal, whether the second preset identifier carried by the first data recovery request exists in data stored in the second terminal in response to the first data recovery request;
initiating a second data recovery request for requesting to recover data transferred by the second terminal in response to a command sent by the server for recovering the data of the second terminal, in a case where the data stored in the second terminal does not have the second preset identifier carried by the first data recovery request; and
repeatedly executing the determining whether the second preset identifier carried by the first data recovery request exists in the data stored in the second terminal in response to the first data recovery request when data recovery of the second terminal is completed.

12. The data transmission method according to claim 11, wherein the data transmission method further comprises:
determining whether the second preset identifier is packaged by additional identifiers in response that the second preset identifier carried by the first data recovery request exists in the data stored in the second terminal; and
sending a data packet corresponding to the second preset identifier to the first terminal in response that the second preset identifier is not packaged by the additional identifiers.

13. The data transmission method according to claim 12, wherein the data transmission method further comprises:
monitoring, by the second terminal, whether the terminal corresponding to the additional identifiers sends a third data recovery request, in response that the second preset identifier is packaged by the additional identifiers, so as to send the data packet corresponding to the additional identifiers to the terminals corresponding to the additional in response to the third data recovery request.

14. The data transmission method according to claim 1, wherein the data transmission method further comprises: receiving, by the server, terminal tasks and attribute information reported by the terminals to generate the terminal information of the terminals.

15. The data transmission method according to claim 1, wherein the data transmission method further comprises: periodically determining, by the server, according to the internal storage margin of each terminal, a third terminal that requires to transfer data; determining a second data scheduling plan of the third terminal according to a third data volume of a to-be-transferred data of the third terminal and the terminal information stored in the server, and sending the second data scheduling plan to the third terminal, wherein the second data scheduling plan comprises information of each fourth terminal and a fourth data volume receivable by each fourth terminal, and the fourth terminal is a terminal different from the third terminal within the signal coverage of the gateway; and
receiving, by the third terminal, the second data scheduling plan; and dividing the to-be-transferred data with the third data volume into a plurality of pieces according to the fourth data volume receivable by each fourth terminal, and respectively sending the plurality of pieces to the fourth terminals.

16. The data transmission method according to claim 1, wherein the data transmission method further comprises:
detecting, by the server, an internal storage margin of each terminal, and initiating an internal storage cleaning request to each terminal within the signal coverage of the gateway in response that a total redundant space of the internal storage margin is less than or equal to a third preset threshold; and
uploading, by the terminal, a to-be-cleaned data in the internal storage of the terminal to the server in response to the internal storage cleaning request.

17. A data transmission method, comprising:
determining a first data scheduling plan according to a first data volume of a to-be-transferred data of a first terminal and terminal information received from a server in response to a data scheduling request, wherein the terminal information comprises information of each of terminals in a signal coverage of a gateway, the first data scheduling plan comprises information of each of second terminals and a second data volume receivable by each second terminal, the second terminal is a terminal among the terminals different from the first terminal within the signal coverage of the gateway, and the first terminal is a terminal among the terminals which sends the data scheduling request within the signal coverage of the gateway;
dividing the to-be-transferred data with the first data volume into a plurality of pieces according to the second data volume receivable by each second terminal to obtain each piece of sub-data; and
sending each piece of the sub-data to the corresponding second terminal respectively.

18-23. (canceled)

24. A data transmission device, comprising:
a first processing component configured to determine, in response to a data scheduling request, a first data scheduling plan according to a first data volume of a to-be-transferred data of a first terminal and terminal information received from a server, wherein the terminal information comprises information of each of terminals within a signal coverage of the gateway, the first data scheduling plan comprises information of each of second terminals and a second data volume receivable by each second terminal, the second terminal is a terminal among the terminals different from the first terminal within the signal coverage of the gateway, and the first terminal is a terminal among the terminals which sends the data scheduling request within the signal coverage of the gateway;
a second processing component configured to divide the to-be-transferred data with the first data volume into a plurality of pieces according to the second data volume receivable by each second terminal to obtain each piece of sub-data; and
a sending module configured to send each piece of the sub-data to the corresponding second terminal respectively.

25. A computer device, comprising: a processor, a memory and a bus, wherein the memory stores machine-readable instructions executable by the processor, the processor and the memory are communicated with each other over the bus when the computer device is running, and the machine-readable instructions, when executed by the processor, cause the processor to perform the data transmission method according to claim 1.

26. A non-transitory computer readable storage medium storing a computer program thereon, wherein the computer program, when is executed by a processor, cause the processor to perform the data transmission method according to claim 17.
